(19) United States
(12) Patent Application Publication
(10) Pub. No.: US 2023/0263180 A1
(43) Pub. Date: Aug. 24, 2023

(54) NON-DAIRY BUTTERMILK POWDER DERIVED FROM A HYPOALLERGENIC PLANT-BASED SUBSTRATE

(71) Applicant: Mill It, Inc., Bakersfield, CA (US)

(72) Inventors: Scott Myers, Bakersfield, CA (US); William Myers, Bakersfield, CA (US)

(21) Appl. No.: 18/109,188

(22) Filed: Feb. 13, 2023

Related U.S. Application Data
(60) Provisional application No. 63/309,741, filed on Feb. 14, 2022.

(51) Int. Cl. A23C 11/10

(52) U.S. Cl. CPC A23C 11/106

(57) ABSTRACT

Described herein are powdered or concentrated cultured plant-based dairy alternatives derived from a hypoallergenic plant-based substrates and methods for manufacturing the compositions. In one aspect, the powdered or concentrated cultured plant-based dairy alternative is a powdered buttermilk composition.

### CROSS-REFERENCE TO RELATED APPLICATIONS

This application claims priority to U.S. Provisional Patent Application No. 63/309,741, filed on Feb. 14, 2022, which is incorporated by reference herein in its entirety.

### TECHNICAL FIELD

Described herein are powdered or concentrated cultured plant-based dairy alternatives derived from hypoallergenic plant-based substrates and methods for manufacturing the compositions. In one aspect, the powdered or concentrated cultured plant-based dairy alternative is a powdered buttermilk composition.

### BACKGROUND

Milk and various dairy products are utilized as an ingredient in a number of different food products, including, among other things, milk, yogurt, cheese, salad dressings, ice cream, baked goods, battered and fried foods, cake mix, cereals, chocolate, and many others. Thus, persons suffering from lactose intolerance are limited in the foods they eat. Further complicating their food choices, most of the available non-dairy milk substitutes are made with almonds, cashews, or other nuts. Of course, the United States Food and Drug Administration (“FDA”) classifies such nut-based products as nut allergens. Hypoallergenic is defined as being “below normal” or “slightly” allergenic. Most commercial, plant-based milks and cultured products are made with almonds, cashews, or other nuts.

Nearly all nuts have been associated with fatal allergic reactions. A summary of reports from 1996 to 2014 found nut allergy prevalence ranging from 0.05% to almost 5% of the population. Prevalence of individual nut allergies varied significantly by region: Hazelnut was the most common nut allergy in Europe; walnut and cashew in the USA; and Brazil nut, almond and walnut most commonly reported in the UK.

### SUMMARY

One embodiment described herein is a powdered or concentrated composition comprising: 30-90% by mass of cultured hypoallergenic substrate; 5-10% by mass of one or more plant-based proteins; and 10-50% by mass of one or more starches or fibers. In one aspect, the composition further comprises one or more of: 5-10% by mass of one or more fats; 1-5% by mass of one or more hydrocolloids, texturizers, or stabilizers; 1-5% by mass of one or more plant-based emulsifiers; 1-5% by mass of one or more acidulants. In another aspect, the cultured hypoallergenic substrate comprises: 0.1-3.0% by mass of one or more plant-based carbohydrate sources; 0.8-10% by mass of one or more plant seed butters or creams; 0.1-0.75% by mass of one or more plant-based texturizers or stabilizers; 80-98% by mass of one or more solvents; and 0.001-0.005% by mass of one or more microorganism cultures. In another aspect, the one or more plant-based carbohydrate sources comprises millet, sorghum, quinoa, oat, amaranth, einkorn, teff, freekeh, farro (emmer), fonio, spelt, chia seeds, hemp hearts, buckwheat, or combinations thereof. In another aspect, the one or more plant seed butters or creams comprises sunflower seed butter, coconut cream, pumpkin seed butter, watermelon seed butter, hemp seed butter, chia seed butter, flax seed butter, poppy seed butter, or combinations thereof. In another aspect, the one or more plant-based texturizers or stabilizers comprises one or more of guar gum, locust bean gum, gellan gum, xanthan gum, acacia gum, tragacanth gum, pectin, agar, or combinations thereof. In another aspect, the one or more solvents comprise water. In another aspect, the one or more microorganism cultures comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, Torulaspora delbrueckii, or combinations thereof. In another aspect, the one or more plant-based proteins comprises pea protein concentrate, potato protein concentrate, bean protein concentrate, sunflower seed protein concentrate, rapeseed protein, or combinations thereof. In another aspect, the one or more one or more starches comprise hypoallergenic maltodextrin, food starch, modified food starch, or combinations thereof; and the one or more fibers comprise fruit or vegetable soluble fiber concentrates, pomaces, or combinations thereof. In another aspect, the one or more fats comprises one or more of plant-based oils, butters, or creams, including those from sunflower seed, pumpkin seed, watermelon seed, hemp seed, chia seed, flax seed, poppy seed, coconut cream, or combinations thereof. In another aspect, the one or more hydrocolloids, texturizers, or stabilizers comprises one or more of guar gum, locust bean gum, gellan gum, xanthan gum, acacia gum, tragacanth gum, pectin, agar, or combinations thereof. In another aspect, the one or more plant-based emulsifiers comprises one or more of sunflower lecithin, mono and diglycerides, or combinations thereof. In another aspect, the one or more one or more acidulants comprises citric acid, acetic acid, phosphoric acid, fumaric acid, malic acid, tartaric acid, lactic acid, or combinations thereof. In another aspect, the cultured hypoallergenic substrate comprises: 0.1-3.0% by mass of a flour from one or more of millet, sorghum, quinoa, oat, amaranth, einkorn, teff, freekeh, farro (emmer), fonio, spelt, chia seeds, hemp hearts, buckwheat, or combinations thereof; 0.8-10% by mass of one or more of sunflower seed butter, coconut cream, pumpkin seed butter, watermelon seed butter, hemp seed butter, chia seed butter, flax seed butter, poppy seed butter, or combinations thereof; 0.1-0.75% by mass of one or more of guar gum, locust bean gum, gellan gum, xanthan gum, acacia gum, tragacanth gum, pectin, agar, or combinations thereof; 80-98% by mass of water; and 0.001-0.005% by mass of one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, Torulaspora delbrueckii, or combinations thereof. In another aspect, the cultured hypoallergenic substrate comprises: 0.1-3.0% by mass of a flour from millet, sorghum, or combinations thereof; 0.8-10% by mass of sunflower seed butter, coconut cream, or combinations thereof; 0.1-0.75% by mass of one or more of guar gum, locust bean gum, gellan gum, xanthan gum, or combinations thereof; 80-98% by mass of water; and 0.001-0.005% by mass of one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof. In another aspect, the cultured hypoallergenic substrate comprises: 0.2-0.8% by mass of a flour from millet, sorghum, or combinations thereof; 1.0-1.5% by mass of sunflower seed butter; 3.0-5.0% by mass of coconut cream; 0.2-0.5% by mass of one or more of guar gum, locust bean gum, gellan gum, xanthan gum, or combinations thereof; 92-95% by mass of water; and 0.002-0.004% by mass of one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof. In another aspect, the powdered or concentrated composition is vegan, hypoallergenic, and contains no added monosaccharides or disaccharides.

Another embodiment described herein is a method for manufacturing a concentrated cultured plant-based dairy alternative, the method comprising: combining to form a hypoallergenic slurry: one or more hypoallergenic-substrates comprising ancient grains or pseudo-cereals; sunflower seed butter and coconut cream; one or more stabilizers; and water; pasteurizing and homogenizing the hypoallergenic-slurry to form a pasteurized, homogenized hypoallergenic-slurry; inoculating the pasteurized, homogenized hypoallergenic-slurry with one or more fermentation agents and fermenting for about 4 to 8 hours until the pH is about 4.4 or lower to form a fermented hypoallergenic-slurry; and increasing percent solids of the fermented hypoallergenic-slurry using one or more of reverse osmosis, nanofiltration, mechanical vapor recompression, or combinations thereof to form the concentrated cultured plant-based dairy alternative. In one aspect, the ancient grains or pseudo-cereals comprise one or more of flour from millet and sorghum. In another aspect, the stabilizers comprise one or more of locust bean gum, gellan gum, and xanthan gum. In another aspect, the hypoallergenic-slurry comprises a ratio by weight of: the hypoallergenic-substrates being 0.01% to 3.0% of the weight of the water; and the sunflower seed butter and coconut cream being 0.01% to 5.0% of the weight of the water. In another aspect, the ratio by weight of the sunflower seed butter is 4.9% to 10.0% of the weight of the water. In another aspect, the ratio by weight of the coconut cream is 4.9% to 10.0% of the weight of the water. In another aspect, the fermentation agent comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, and Torulaspora delbrueckii. In another aspect, one or more of starches or fibers; fats; hydrocolloids, texturizers, or stabilizers; plant-based emulsifiers; acidulants, or combinations thereof are added to the fermented hypoallergenic-slurry prior to increasing percent solids.

Another embodiment described herein is a method for manufacturing a powdered cultured plant-based dairy alternative, the method comprising: combining to form a hypoallergenic slurry: one or more hypoallergenic-substrates comprising ancient grains or pseudo-cereals; sunflower seed butter and coconut cream; one or more stabilizers; and water; pasteurizing and homogenizing the hypoallergenic-slurry to form a pasteurized, homogenized hypoallergenic-slurry; inoculating the pasteurized, homogenized hypoallergenic-slurry with one or more fermentation agents and fermenting for about 4 to 8 hours until the pH is about 4.4 or lower to form a fermented hypoallergenic-slurry; and drying the fermented hypoallergenic-slurry to form the powdered cultured plant-based dairy alternative. In one aspect, drying comprises spray drying, freeze drying, drum drying, pulse drying, or combinations thereof. In another aspect, the method further comprises agglomerating the powdered cultured plant-based dairy alternative. In another aspect, the ancient grains or pseudo-cereals comprise one or more of flour from millet or sorghum. In another aspect, the stabilizers comprise one or more of guar gum, locust bean gum, gellan gum, or xanthan gum. In another aspect, the hypoallergenic-slurry comprises a ratio by weight of: the hypoallergenic-substrates being 0.01% to 3.0% of the weight of the water; and the sunflower seed butter and coconut cream being 0.01% to 5.0% of the weight of the water. In another aspect, the ratio by weight of the sunflower seed butter is 4.9% to 10.0% of the weight of the water. In another aspect, the ratio by weight of the coconut cream is 4.9% to 10.0% of the weight of the water. In another aspect, the fermentation agent comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, and Torulaspora delbrueckii. In another aspect, one or more of starches or fibers; fats; hydrocolloids, texturizers, or stabilizers; plant-based emulsifiers; acidulants, or combinations thereof are added to the fermented hypoallergenic-slurry prior to drying.

Another embodiment described herein is a method for manufacturing a powdered or concentrated cultured plant-based dairy alternative, the method comprising: combining a plant-based dairy alternative substrate and one or more starches or fibers; fats; hydrocolloids, texturizers, or stabilizers; plant-based emulsifiers; acidulants, or combinations thereof to form to form a mixture; and concentrating or drying the mixture. In one aspect, the plant-based dairy alternative substrate is manufactured by: combining and blending one or more plant-based carbohydrate sources, one or more plant seed butters or creams, one or more plant-based texturizers or stabilizers, and one or more solvents to form a blended composition; pasteurizing the blended composition; homogenizing the blended composition to form a homogenized composition; cooling the homogenized composition; adding one or more microorganism cultures to the cooled, homogenized composition; fermenting the composition until the pH is about 4.4 or lower; and cooling the fermented composition to about 4° C.

Another embodiment described herein is a method for manufacturing a powdered or concentrated cultured plant-based dairy alternative, the method comprising: providing a plant-based dairy alternative substrate; drying the plant-based dairy alternative substrate; combining the dried plant-based dairy alternative substrate with one or more starches or fibers; fats; hydrocolloids, texturizers, or stabilizers; plant-based emulsifiers; acidulants to form a blend; and agglomerating the blend. In one aspect, the plant-based dairy alternative substrate is manufactured by: combining and blending one or more plant-based carbohydrate sources, one or more plant seed butters or creams, one or more plant-based texturizers or stabilizers, and one or more solvents to form a blended composition; pasteurizing the blended composition; homogenizing the blended composition to form a homogenized composition; cooling the homogenized composition; adding one or more microorganism cultures to the cooled, homogenized composition; fermenting the composition until the pH is about 4.4 or lower; and cooling the fermented composition to about 4° C.

Another embodiment described herein is a method for manufacturing a powdered or concentrated cultured plant-based dairy alternative, the method comprising: combining a dried plant-based dairy alternative substrate and one or more of dried starches or fibers; fats; hydrocolloids, texturizers, or stabilizers; plant-based emulsifiers; acidulants to form a dry admixture. In one aspect, the dried plant-based dairy alternative substrate is manufactured by: combining and blending one or more plant-based carbohydrate sources, one or more plant seed butters or creams, one or more plant-based texturizers or stabilizers, and one or more solvents to form a blended composition; pasteurizing the blended composition; homogenizing the blended composition to form a homogenized composition; cooling the homogenized composition; adding one or more microorganism cultures to the cooled, homogenized composition; fermenting the composition until the pH is about 4.4 or lower; cooling the fermented composition to about 4° C.; and drying the fermented composition to form the dried plant-based dairy alternative substrate.

### DESCRIPTION OF THE DRAWINGS

FIG. 1 shows a flow diagram that depicts an exemplary method for making a hypoallergenic, plant-based dairy alternative.

FIG. 2 shows a flow diagram that depicts an alternative exemplary method for creating a hypoallergenic, plant-based dairy alternative that is fermented.

FIG. 3 shows a flow diagram that depicts alternative exemplary methods for creating a hypoallergenic, plant-based dairy alternative based on alternative substrates.

FIG. 4 shows a flow diagram that depicts one alternative method wherein various types of hypoallergenic substrates are combined with water.

FIG. 5-7 show flow diagrams that depict alternative methods for combining water with a hypoallergenic substrate based on a range of ratios of mass percentages.

FIG. 8A-9B show flow diagrams that depict alternative methods for combining water with a plant-based butter and/or cream based on a range of ratios of mass percentages.

FIG. 10 shows a flow diagram that depicts alternative exemplary methods for subjecting the hypoallergenic, dairy alternatives to a preservation process.

FIG. 11-12 show flow diagram that depict alternative methods for inoculating a hypoallergenic, dairy alternative.

FIG. 13 shows a flow diagram that depicts alternative exemplary methods for inoculating a hypoallergenic slurry with a fermentation agent.

FIG. 14 shows a flow diagram that depicts yet additional alternative exemplary methods for inoculating a hypoallergenic slurry with a fermentation agent.

FIG. 15 shows a flow diagram that depicts yet additional alternative exemplary methods for inoculating a hypoallergenic slurry with a fermentation agent.

FIG. 16 shows a flow diagram that depicts yet additional alternative exemplary methods for inoculating a hypoallergenic slurry with a probiotic strain.

FIG. 17A-18D show flow diagrams that depict alternative methods for adjusting the pH of a hypoallergenic slurry.

FIG. 19-20 show flow diagrams that depict alternative exemplary methods wherein a plant-based protein is added to a fermented hypoallergenic slurry.

FIG. 21-22 show flow diagrams that depict alternative exemplary methods wherein a prebiotic soluble fiber is added to a fermented hypoallergenic slurry.

FIG. 23 shows a graph of the pH value versus time for the fermentation of three production runs of the plant-based dairy alternative and the average of the three runs. The cultured plant-based dairy alternative composition as described herein reaches a pH of about 4.4 in about 6 to 6.6 hours after commencing fermentation. Achieving the pH in this time period is surprisingly rapid as compared to typical plant-based fermentation products.

### DETAILED DESCRIPTION

Unless otherwise defined, all technical and scientific terms used herein have the same meaning as commonly understood by one of ordinary skill in the art. For example, any nomenclatures used in connection with, and techniques of, food production and formulation, fermentation, microbiology, biochemistry, and molecular biology, described herein are known and commonly used in the art. In case of conflict, the present disclosure, including definitions, will control. Exemplary methods and materials are described below, although methods and materials similar or equivalent to those described herein can be used in practice or testing of the embodiments and aspects described herein.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “a,” “an,” “the” and similar terms used in the context of the disclosure (especially in the context of the claims) are to be construed to cover both the singular and plural unless otherwise indicated herein or clearly contradicted by the context. In addition, “a,” “an,” or “the” means “one or more” unless otherwise specified.

As used herein, the term “or” can be conjunctive or disjunctive.

As used herein, the term “substantially” means to a great or significant extent, but not completely.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art. Alternatively, such as with respect to biological systems or processes, the term “about” can mean within an order of magnitude, in some embodiments within 5-fold, and in some embodiments within 2-fold, of a value. As used herein, the symbol “˜” means “about” or “approximately.”

All ranges disclosed herein include both end points as discrete values as well as all integers, fractions, and subranges within the specified range. For example, a range of 0.1-2.0 includes 0.1, 0.2, 0.3, 0.4 . . ., 1.0, . . . 2.0, and 0.5-1.0. If the end points are modified by the term “about,” the range specified is expanded by a variation of up to ±10% of any value within the range or within 3 or more standard deviations, including the end points.

As used herein, the terms “control,” or “reference” are used herein interchangeably. A “reference” or “control” level may be a predetermined value or range, which is employed as a baseline or benchmark against which to assess a measured result. “Control” also refers to control experiments.

As used herein, the term “mass percent” refers to the mass of a component or group of components as a percentage of the total mass of the composition or sub-composition.

As used herein, the term “percent solids” refers to the mass of one or more solid materials present in a liquid, semi-liquid, emulsion, gel, or other composition. As used herein, the term “liquid” refers to a solution where one or more components may not dissolve completely in the solvent. A “semi-liquid” refers to a composition where the mass of solids are equal to or exceed the mass of solvent. As used herein, an “emulsion” refers to a mixture of two or more liquids or components that are normally immiscible owing to phase separation; the components may be liquids, semi-liquids, solids, or semisolids. An emulsion may be stabilized from phase separation by the addition of an emulsifier or stabilizer. As used herein, a “gel” refers to a semi-solid composition that exhibits no flow at steady-state, although solvated components in the liquid phase may still diffuse through the system.

As used herein, “fermented” refers to a composition that has been produced using controlled microbial growth, permitting the conversion of components through enzymatic action.

As used herein, the term “hypoallergenic” refers to a product that does not contain allergens, or contains fewer allergens, and does not produce significant allergic reactions in subjects that consume or are contacted by the product.

As used herein, the phrase “plant-based dairy alternative” refers to a composition comprising only plant components that has a composition, consistency, or taste similar to a dairy or milk-based product.

As used herein, the phrase “plant-based dairy alternative substrate” refers to a composition comprising one or more of carbohydrate sources; plant seed butters or creams; texturizers or stabilizers; solvents; optional plant-based protein concentrates and/or prebiotic soluble plant fibers; and microorganism cultures (fermentation agents). The composition is fermented. The composition may be used as a liquid, concentrate, dried powder, or agglomerated composition when used as a substrate for the concentrated, dried powder, or agglomerated compositions described herein.

As used herein, “concentrate” refers to a liquid composition that has had some fraction of the solvent removed by evaporation, dehydration, filtration, or other means.

As used herein, “powdered” refers to a bulk solid of particles that is typically free flowing. In one aspect, “powdered” refers to a dehydrated liquid or emulsion as described herein.

As used herein, “agglomerated” refers to a bulk solid of particles that adhere to one another form aggerates or clumps. The agglomeration process typically consists of suspending powders in an upwardly moving column of air while simultaneously injecting a controlled and defined amount of liquid into the powder stream to produce a moistened state of the powder; mild heat may be then used to dry the material, producing an agglomerated composition.

### Compositions

One embodiment described herein is a composition for a fermented food product. In one aspect, the product is a vegan, non-GMO, hypoallergenic, cultured, plant-based dairy alternative produced from fermenting ancient grains and plant proteins and butters and creams. In one aspect, the composition contains flour of one or more ancient grains, one or more seed butters, one or more plant-based creams, one or more texturizers or stabilizers, and water that is cultured to form a dairy alternative food product. In one aspect, the food product is hypoallergenic and contains no added monosaccharides or disaccharides (sugars). In another aspect, the composition optionally contains plant-based protein concentrates, prebiotic soluble plant fiber, or a combination thereof. Exemplary components of the product are shown in Tables 1-2.

TABLE 1
Exemplary Plant-based Dairy Alternative Substrate Composition and Mass Percentages

| | | Mass |
|---|---|---|
| Component/Function | Exemplary Components | Percent (%) |
| Carbohydrate | Ancient grain flours including millet, sorghum, quinoa, | 0.1-3.0 |
| sources | oat, amaranth, teff, freekeh, farro (emmer), fonio, spelt, | |
| | chia seeds, hemp hearts, buckwheat, or combinations | |
| | thereof | |
| Plant seed butters or | Plant-based butters or creams, including sunflower | 0.8-10 |
| creams | seed, pumpkin seed, watermelon seed, hemp seed, | |
| | chia seed, flax seed, poppy seed, coconut cream, or | |
| | combinations thereof | |
| Texturizers or | Gums including guar gum, locust bean gum, gellan | 0.1-0.75 |
| stabilizers | gum, xanthan gum, acacia gum, tragacanth gum, | |
| | pectin, agar, or combinations thereof | |
| Solvents | Water | 80-98 |
| Optional plant-based | Pea protein concentrate, potato protein concentrate, | 0.02-6% |
| protein concentrates | bean protein concentrate, sunflower seed protein | (0.01-3% |
| and/or prebiotic | concentrate, rapeseed protein or combinations thereof | each) |
| soluble plant fibers | Fruit or vegetable soluble fiber concentrates or | |
| | pomaces or combinations thereof | |
| Microorganism | Bifidobacterium lactis, Lactobacillus acidophilus, | 0.001-0.005% |
| cultures | Lactobacillus delbrueckii subsp. Bulgaricus, | |
| (fermentation agents) | Lactobacillus delbrueckii subsp. Lactis, | |
| | Lactobacillus helveticus, Lactobacillus kefiranofaciens, | |
| | Lactobacillus paracasei, Lactobacillus plantarum, | |
| | Lactococcus lactis, | |
| | Leuconostoc spp., Pediococcus spp., | |
| | Streptococcus thermophilus, Kazachstania unispora, | |
| | Kluyveromyces lactis, Kluyveromyces marxianus, | |
| | Saccharomyces cerevisiae, Saccharomyces fragilis, | |
| | Torulaspora delbrueckii, or combinations thereof. | |

All mass percent rages are exemplary and include all integers, end points, and subranges within the specified ranges.

The plant-based dairy alternative substrate shown in Table 1 is used as the basis for a powdered, concentrated, or agglomerated plant-based dairy alternative as shown in Table 2. The additional components may be combined prior to drying, evaporating, concentrating, or agglomeration. Alternatively, the plant-based dairy alternative substrate may be dried, evaporated, concentrated, or agglomerated and then combined with additional dry ingredients to achieve the final product composition.

TABLE 2
Exemplary Powdered or Concentrated Plant-based Dairy
Alternative Composition and Mass Percentages

| Component/Function | Exemplary Components | Mass Percent (%) |
|---|---|---|
| Cultured hypoallergenic substrate | See Table 1 | 30-90% |
| Plant-based Proteins | Pea protein concentrate, potato | 5-10% |
| | protein concentrate, bean protein | |
| | concentrate, sunflower seed protein | |
| | concentrate, rapeseed protein, or | |
| | combinations thereof | |
| Starches or Fibers | Hypoallergenic maltodextrin, food | 10-50% |
| | starch, modified food starch, or | |
| | combinations thereof; | |
| | Fruit or vegetable soluble fiber | |
| | concentrates, pomaces, or | |
| | combinations thereof | |
| Optional Fats | Plant-based oils, butters, or creams, | 5-10% |
| | including those from sunflower | |
| | seed, pumpkin seed, watermelon | |
| | seed, hemp seed, chia seed, flax | |
| | seed, poppy seed, coconut cream, | |
| | or combinations thereof | |
| Optional Hydrocolloids, | Gums including guar gum, locust | 1-5% |
| Texturizers, or stabilizers | bean gum, gellan gum, xanthan | |
| | gum, acacia gum, tragacanth gum, | |
| | pectin, agar, or combinations | |
| | thereof | |
| Optional Emulsifiers | Plant-based emulsifiers, such as | 1-5% |
| | sunflower lecithin, mono and | |
| | diglycerides, and the like, or | |
| | combinations thereof | |
| Optional Acidulants | Citric acid, acetic acid, phosphoric | 1-5% |
| | acid, fumaric acid, malic acid, | |
| | tartaric acid, lactic acid, or | |
| | combinations thereof | |

All mass percent rages are exemplary and include all integers, end points, and subranges within the specified ranges. Optional components are not required but may be added.

In one embodiment the composition comprises one or more carbohydrate sources. In one aspect, the carbohydrate source is an extract or flour from one or more ancient grains. Ancient grains include grains and pseudocereals that have not undergone selective breeding. Exemplary ancient grains include millet, sorghum, quinoa, oat, amaranth, teff, freekeh, farro (emmer), fonio, spelt, chia seeds, hemp hearts, buckwheat, or combinations thereof. These ancient grains are hypoallergenic and provide complex carbohydrates which can be utilized by the cultures during fermentation. In one embodiment, the ancient grains comprise flours of millet, sorghum, or a combination thereof. In the composition, the ancient grains are typically present in an amount of about 0.1% to about 5% by mass, including all integers and subranges within the specified range. In one aspect, the ancient grains or components thereof comprise 0.1% to about 3% by mass of the composition, including all integers and subranges within the specified range. One or more of the ancient grains or components thereof can comprise about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, or about 5.0% by mass of the composition. In one aspect, one or more of the ancient grains or components thereof can comprise about 0.1-1.0%; 0.2-0.8%, 0.3-0.6%, 0.4-0.5%, 0.1-1%, 0.1-2%, 0.1-3%, 0.1-4%, 0.2-1%, 0.3-1%, 0.4-1%, 0.5-1%, 0.6-1%, 0.7-1%, 0.2-0.6, 0.2-0.8, 0.3-0.3-0.6%, 0.3-0.8%, 0.4-0.5%, 0.4-0.6%, 0.4-0.8%, 0.5-0.6%, 0.5-0.7%, 0.5-0.8%, or about 0.6-0.8% by mass, including all integers and subranges within the specified ranges. In one aspect, the one or more of the ancient grains or components thereof comprises about 0.2-0.8% by mass of the composition, including all integers and subranges within the specified range.

The composition also contains plant seed butters or creams. In one aspect, the plant seed butters or creams comprise high amounts of polyunsaturated fatty acids and monounsaturated fatty acids in addition to carbohydrates, proteins, fiber. In another aspect, the plant seed butters or creams are hypoallergenic. In one embodiment, the plant seed butters or creams comprise sunflower seed butter, pumpkin seed butter, watermelon seed butter, hemp seed butter, chia seed butter, flax seed butter, poppy seed butter, coconut cream, or combinations thereof. In one embodiment, the plant seed butter or cream comprises sunflower butter. In one embodiment, the plant seed butter or cream comprises coconut cream. Coconut cream is desirable because it has dairy notes and provides the composition a dairy flavor profile. In one embodiment, the plant seed butter or cream comprises a combination of sunflower butter and coconut cream. The plant seed butter or cream comprises about 0.8% to about 10% by mass of the composition, including all integers and subranges within the specified range. In one aspect, the plant seed butter or cream can comprise about 0.8, 0.9, 1.0, 1.1, 1.2, 1.3, 1.4, 1.5, 1.6, 1.7, 1.8, 1.9, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, 6.0, 6.2, 6.4, 6.6, 6.8, 7.0, 7.2, 7.4, 7.6, 7.8, 8.0, 8.2, 8.4, 8.6, 8.8, 9.0, 9.2, 9.4, 9.6, 9.8, or about 10.0% by mass of the composition. In another aspect, the plant seed butter or cream comprises about 0.8-10%, 0.9-8%, 1.0-7%, 1.0-6%, 1.0-1.4%, 1.0-1.5%,1.0-1.6%, 1.2-1.5%, 1.1-1.5%, 1.1-1.4%, 1.2-1.4%, 0.9-2% 1.0-2%, 1.1-2%, 1.2-2%, 1.3-2%, 1.4-2%, 1.5-2%, 1.6-2%, 2-3, 2-4, 2-5, 2-6, 2-7, 2.5-5, 2.5-7, 2.5-8, 3-5, 3-7, 3-8, 4-5, 4-6, 4-8, 5-7, 5-8, 6-7, or about 6-8% by mass, including all integers and subranges within the specified ranges. In one embodiment, the one or more plant seed butters comprise about 1% to about 1.5% by mass of the composition and the one or more plant creams comprise about 3 to about 5% by mass of the composition, for a total percentage of about 4-7% by mass, including all integers and subranges within the specified range.

The composition also contains one or more plant-based texturizers or stabilizers. In one embodiment the plant-based texturizers or stabilizers comprise one or more of guar gum, locust bean gum, gellan gum, xanthan gum, acacia gum, tragacanth gum, pectin, agar, or combinations thereof. In one embodiment the texturizers or stabilizers comprise one or more of guar gum, locust bean gum, gellan gum, or xanthan gum. The plant-based texturizers or stabilizers comprise about 0.1% to about 1% by mass of the composition, including all integers within the range. In one aspect, the plant-based texturizers or stabilizers comprise about 0.1, 0.2, 0.3, 0.4, 0.5, 0.6, 0.7, 0.8, 0.9, to about 1.0 by mass of the composition. In another aspect, the plant-based texturizers or stabilizers comprise about 0.1-0.8, 0.2-0.7, 0.3-0.5, 0.1-0.2, 0.1-0.3, 0.1-0.5, 0.1-0.7, 0.1-0.8, 0.2-0.3, 0.2-0.4, 0.2-0.5, 0.2-0.6, 0.2-0.8, 0.3-0.6, 0.4-0.8, 0.5-1, 0.6-1, or about 0.8-1% by mass of the composition, including all integers and subranges within the specified ranges. In one aspect, the plant-based texturizers or stabilizers comprise about 0.2 to about 0.5% by mass of the composition, including all integers and subranges within the specified range.

The composition contains one or more solvents. In one embodiment the solvent is purified water. The composition comprises water in an amount of about 80% to about 98% by mass of the composition, including all integers and subranges within the specified range. In one aspect, the water comprises about 80, 81, 82, 83, 84, 85, 86, 87, 88, 89, 90, 91, 92, 93, 94, 95, 96, 97, or about 98% by mass of the composition. In one aspect, the water comprises about 92% to about 95% of the composition by mass, including all integers and subranges within the specified range.

The composition comprises one or more microorganism cultures or fermentation agents. The culture can comprise bacteria, yeasts, or combinations thereof. Exemplary microorganisms for fermentation comprise one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, Torulaspora delbrueckii, or combinations thereof. In one aspect, the microorganism cultures can comprise about 0.001% to about 0.01% by mass of the composition, including all integers within the range. In another aspect, the culture can comprise about 0.001, 0.002, 0.003, 0.004, 0.005, 0.006, 0.007, 0.008, 0.009, or about 0.01% by mass of the composition. In another aspect the culture comprises 0.001-0.002, 0.001-0.003, 0.001-0.004, 0.001-0.005, 0.001-0.006, 0.001-0.007, 0.001-0.008, 0.001-0.009, 0.002-0.003, 0.002-0.005, 0.002-0.008, 0.003-0.005, 0.001-0.008, 0.004-0.006, 0.004-0.008, or 0.005-0.008% by mass of the composition, including all integers and subranges within the specified ranges. In one aspect, the culture comprises about 0.002% to about 0.004% by mass of the composition, including all integers and subranges within the specified range.

The composition can optionally contain plant-based protein concentrates or prebiotic soluble fiber sources. Exemplary plant-based protein concentrations comprise pea protein concentrate, potato protein concentrate, bean protein concentrate, sunflower seed protein concentrate, rapeseed protein or combinations thereof. Exemplary plant-based fiber sources include fruit and vegetable fiber concentrates or pomaces or combinations thereof. The composition can comprise combined plant-based protein concentrates and/or fiber sources at about 0.02 to about 6% by mass of the composition, including all integers within the range (e.g., about 0.01 to about 3% of one or more protein concentrates and about 0.25 to about 3% of one or more prebiotic soluble fiber sources). In one aspect, the composition comprises combined plant-based protein concentrates and/or prebiotic soluble fiber sources at about 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.2, 1.4, 1.6, 1.8, 2.0, 2.2, 2.4, 2.6, 2.8, 3.0, 3.2, 3.4, 3.6, 3.8, 4.0, 4.2, 4.4, 4.6, 4.8, 5.0, 5.2, 5.4, 5.6, 5.8, or about 6.0% by mass of the composition. In another aspect, the composition comprises combined plant-based protein concentrates and/or prebiotic soluble fiber sources at about 0.001-5, 0.05-5, 0.1-5, 0.01-1, 0.05-1, 0.5-5, 0.5-4, 0.5-3, 0.5-2, 0.5-1, 1-2, 1-3, 1-4, 1-5, 2-3, 2-4, 2-5, 3-4, 3-5, or about 4-5% by mass of the composition. In one aspect, the composition comprises combined plant-based protein concentrates and/or prebiotic soluble fiber sources at about 0.5% to about 3% by mass of the composition, including all integers and subranges within the specified range.

In one embodiment, the plant-based dairy alternative comprises about 0.2-0.8% by mass of one or more of the ancient grains or components thereof; about 4-8% by mass of one or more plant seed butters or creams; about 0.2-0.5% by mass of one or more plant-based texturizers or stabilizers; about 92-95% by mass water; and about 0.002-0.004% by mass of one or more microorganism cultures, including all integers and subranges within the specified ranges. In one aspect, the ancient grains comprise millet and sorghum flours; the plant seed butter or cream comprises sunflower seed butter and coconut cream; the texturizers or stabilizers comprise one or more of guar gum, locust bean gum, gellan gum, or xanthan gum; and the microorganism comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., or Streptococcus thermophilus. Optionally, the plant-based dairy alternative can comprise about 0.5-3.0% of each of plant-based protein concentrates and/or prebiotic soluble plant-based fiber sources.

In another aspect, the composition comprises a powdered or concentrated composition comprising: 30-90% by mass of cultured hypoallergenic substrate; 5-10% by mass of one or more plant-based proteins; and 10-50% by mass of one or more starches or fibers. In one aspect, the composition further comprises one or more of: 5-10% by mass of one or more fats; 1-5% by mass of one or more hydrocolloids, texturizers, or stabilizers; 1-5% by mass of one or more plant-based emulsifiers; 1-5% by mass of one or more acidulants.

### Methods

Another embodiment described herein is a method for manufacturing a cultured plant-based dairy alternative that is a substrate for the powdered or concentrated cultured plant-based dairy alternative. The manufacturing method comprises combining components into a high-shear mixer, blending the batch at high shear until it is smooth, and the texturizers or stabilizers are dispersed, and no clumps are formed. The composition is transferred to a batch kettle and mixed with gentle agitation until the pasteurization/homogenization steps. Prior to pasteurization, the composition is preheated to 40-48° C. (107-117° F.). Pasteurization can be performed using either high temperature short time pasteurization (HTST) or ultra-high temperature pasteurization (UHT). For HTST, the composition is pasteurized at 93° C. (200° F.) followed by homogenization at 93° C. (200° F.), 500/1500 psi for 7 minutes. For UHT, the composition is pasteurized 138-150° C. (280-302° F.) for one or two seconds, followed by homogenization at 93° C. (200° F.), 500/1500 psi for up to 3 seconds. Following pasteurization/homogenization, the mixture is cooled to about 40° C. (106° F.). The microorganism cultures are added and mixed and the composition is allowed to ferment at −40° C. (106° F.) for about 4-8 hours or until the pH reaches 4.4 or lower. Following culturing, the composition is transferred to a cooling tank and held at 4° C. (39° F.).

As used herein the term “hypoallergenic substrate” refers to one or more carbohydrate sources, typically one or more ancient grains or flours or extracts thereof, that are hypoallergenic.

As used herein the term “hypoallergenic-slurry” refers to a composition comprising one or more “hypoallergenic substrates” or carbohydrate sources, one or more plant seed butters or creams, one or more plant-based texturizers or stabilizers, or combinations thereof, and one or more solvents.

As used herein the term “fermented hypoallergenic-slurry” or “cultured hypoallergenic slurry” refers to a composition comprising one or more “hypoallergenic substrates” or carbohydrate sources, one or more plant seed butters or creams, one or more texturizers or stabilizers, or combinations thereof, and one or more solvents that has optionally been pasteurized and homogenized, cooled, and then inoculated with one or more microorganism cultures and allowed to ferment for a period of time. In one aspect, the period of time for fermentation is from about 4 to about 8 hours. In one aspect as used herein, the “fermented hypoallergenic-slurry” is referred to as a “cultured hypoallergenic substrate.”

It should likewise be appreciated that the method steps herein described are useful in manufacture of a composition of matter, which various embodiments are claimed as well. The composition of matter is evident from the method of production and from the claims hereto appended. When a composition is formed for a cultured product, there will remain a latent fermentation agent. A latent fermentation agent is defined herein as a fermentation agent that is substantially not active at lower pH levels. The stated combinations are, contrary to ordinary fermentation of dairy and plant-based matter, less likely to post acidify.

Cultured plant-based dairy alternatives are described in U.S. Pat. No. 11,540,545; U.S. Pat. App. Pub. Nos. US 2020/0037645 A1 and US 2022/0256877 A1, and pending U.S. patent application No. 18/086,492, each of which is incorporated by reference herein for such teachings.

The cultured plant-based dairy alternative based on fermented ancient grains that is used as the substrate for the concentrated or powered plant-based dairy alternative is manufactured by combining and blending one or more plant-based carbohydrate sources; one or more plant seed butters or creams; one or more plant-based texturizers or stabilizers; and one or more solvents; pasteurizing the blended composition; homogenizing the blended composition; cooling the homogenized composition; adding the one or more microorganism cultures to the blended, pasteurized, homogenized, and cooled composition; fermenting the composition until the pH is about 4.4 or lower; and cooling the fermented composition to about 4° C. In one aspect, the combined composition is blended at high shear until the composition is smooth and uniform. In another aspect, the blended composition is pre-heated prior to pasteurization. In another aspect, the blended composition is pasteurized using high temperature, short time (HTST) pasteurization or ultra-high temperature (UHT) pasteurization. In another aspect, the composition is homogenized at a high temperature. In another aspect, the composition is cooled to about ˜40° C. prior to adding the one or more microorganism cultures. In another aspect, the composition is fermented for about 4-8 hours at about ˜40° C. In another aspect, the composition is fermented until the pH is about 4.4 or lower.

A concentrated or powdered cultured plant-based dairy alternative may be manufactured by any of the following methods using the cultured plant-based dairy alternative substrate described herein.

A first method for manufacturing a powdered or concentrate cultured plant-based dairy alternative comprises adding plant-based proteins, fats, carbohydrates, and other ingredients to the plant-based dairy alternative substrate disclosed above prior to the drying process. The composition is blended and then may be stored for a period of time prior to drying. Addition of these ingredients provide nutritional and/or functional benefits to the plant-based dairy alternative as needed.

A second method for manufacturing a powdered or concentrate cultured plant-based dairy alternative comprises the addition of plant-based proteins, fats, carbohydrates, and other ingredients to the cultured plant-based dairy alternative substrate immediately prior to the drying process (e.g., at the drying facility). Addition of these ingredients allows the addition of nutritional and/or functional benefits to the cultured plant-based dairy alternative as needed.

A third method for manufacturing a powdered or concentrate cultured plant-based dairy alternative comprises the addition of plant-based proteins, fats, carbohydrates, and other ingredients to the cultured plant-based dairy alternative powder after it is in dried powder form. These ingredients are blended together or blended and then agglomerated with industrial powder blenders including but not limited to ribbon, V, or tumble blenders. Blending followed by agglomeration permits the addition of heat sensitive ingredients after drying and creating a particle that disperses well in liquids and blends well with other powders like but not limited to biscuit and cake mixes. The latter method is preferred due to its relative simplicity.

A fourth method for manufacturing a powdered or concentrated cultured plant-based dairy alternative comprises combining dry ingredients to form a dry admixture. In this method all components are dried or concentrated prior to combination. The following plant-based, non-allergic dry ingredients may be used to form the cultured plant-based dairy alternative: maltodextrin, natural or modified starches, fibers, proteins, and acidulants that may or may not be encapsulated. Acidulants can include but are not limited to citric acid, acetic acid, phosphoric acid, fumaric acid, malic acid, tartaric acid, and lactic acid. The choice of acidulant will depend on their source, flavor profile, and application compatibility. The acidulant can be encapsulated to prevent it from acting too quickly.

The powered or concentrated cultured plant-based dairy alternative may be manufactured by the following methods. The cultured hypoallergenic plant-based slurry can be concentrated by itself or with the added maltodextrins, starches, fibers, and proteins involved in a concentration process as described herein. The percent solids in the slurry concentration may be increased from about 3-10% solids to about 18-25% solids using reverse osmosis (RO) or a combination of RO and nanofiltration (NF). If the percent solids is above about 25-30%, mechanical vapor recompression (MVR) evaporation may be used to further concentrate the slurry. MVR may increase the percent solids from as low as about 20% to about 45-65%.

The components may be blended with ribbon mixers, tumble mixers, or other mixers known in the industry. The resulting blend may be evaporated or dried by methods known in the art such as spray drying, freeze drying, drum drying, pulse drying, and the like. Following drying, the blend may be agglomerated by methods known in the art. Drying and agglomeration may provide better blending and incorporation of the cultured plant-based dairy alternative into other food applications.

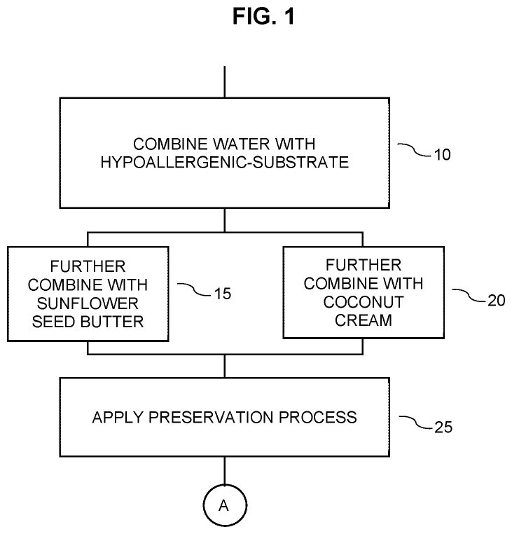

FIG. 1 shows a flow diagram that depicts one exemplary method for making a hypoallergenic, plant-based dairy alternative. In one embodiment the hypoallergenic, plant-based dairy alternative is a cultured buttermilk product. According to this exemplary method, a hypoallergenic, plant-based dairy alternative is made by creating a hypoallergenic-slurry by combining water with a hypoallergenic substrate (Step 10). In continuation of creating the hypoallergenic-slurry, the water is further combined with a sunflower seed butter (Step 15). In one alternative method, the hypoallergenic-slurry is created by further combining the water with a coconut cream (Step 20). In this exemplary method, the hypoallergenic-slurry is then subject to a preservation process (Step 25). It should likewise be appreciated that, according to various alternative example methods, a stabilizer is also added to the hypoallergenic-slurry in order to help retard separation of a plant-based butter and/or cream from the water and/or the hypoallergenic substrate.

It is to be appreciated that a hypoallergenic, plant-based vegan substrate produced according to the present disclosure may be utilized to produce a variety of substitute products which otherwise utilize dairy-based ingredients, including cow's milk. It is to be further appreciated that the resulting non-dairy replacement products contain no nuts and may also be formulated to contain no added monosaccharides and/or disaccharides. One such product which may be produced with the hypoallergenic, plant-based vegan substrate is a powdered buttermilk replacement product.

It should be appreciated that the hypoallergenic-plant-based vegan substrate, including the buttermilk replacement product, provide a base for many varying products, including, for example, a salad dressing. It should be appreciated that any such illustrative use cases, including application of the hypoallergenic, plant-based vegan product as a base for a salad dressing, is not intended to limit the scope of the claims appended hereto.

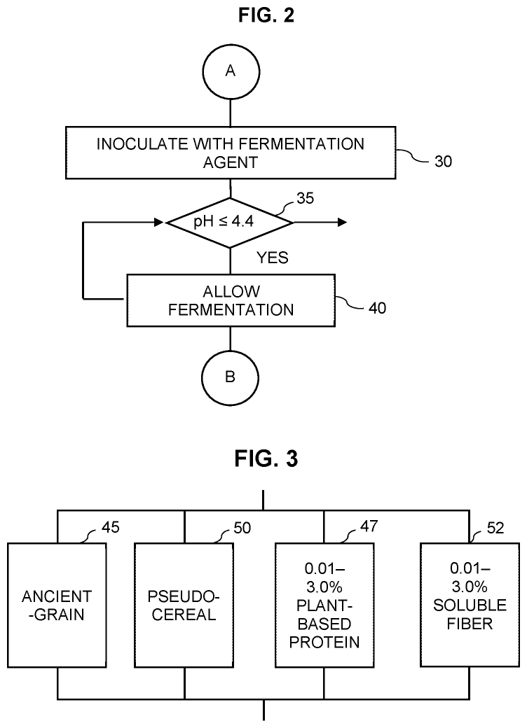

FIG. 2 shows a flow diagram that depicts one alternative exemplary method for creating a hypoallergenic, plant-based dairy alternative that is also fermented. The hypoallergenic, plant-based dairy alternative heretofore described is also useful as a basis for other products, including cultured substitutes for dairy products. According to one alternative exemplary method, making a hypoallergenic, plant-based dairy alternative further comprises an included step for inoculating the hypoallergenic-slurry with a fermentation agent (Step 30). Once the hypoallergenic-slurry is inoculated with the fermentation agent, it is allowed to ferment (Step 40) until it reaches a pH of 4.4 or lower (Step 35).

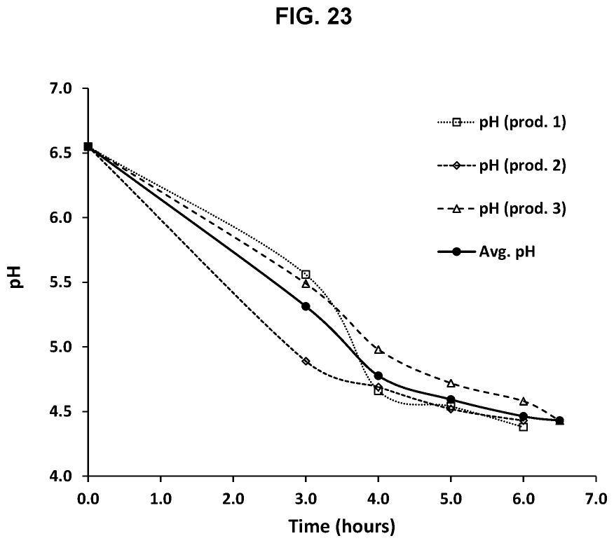

Surprisingly, there exists a synergy in the stated formulation of the hypoallergenic-slurry. The unique combination of the plant-based butter, plant-based cream, and the ancient grains or pseudocereals surprising facilitates fermentation at a faster rate than expected and achieves a lower pH than expected or when the individual components are fermented separately. See FIG. 23, which shows that exemplary compositions as described herein reach a pH of about 4.4 in about 6 hours on average. This is much faster than typical plant-based compositions inoculated with the standard fermentation inoculation culture dose. Many plant-based compositions also require higher doses of fermenting organisms to achieve the desired pH in reasonable time.

FIG. 3 shows a flow diagram that depicts alternative exemplary methods for creating a hypoallergenic, plant-based dairy alternative based on alternative substrates. The term hypoallergenic “plant milk” or “non-dairy milk” refers to a liquid that resembles dairy milk but is made from hypoallergenic plant-based ingredients. Said hypoallergenic plant-based substrate comprises at least one or more of proteins, fats, carbohydrates, vitamins, or minerals. It should be appreciated that dairy allergens, lactose, cholesterol, soy, or tree nut allergens are not included. According to one alternative exemplary embodiment, the method for creating a hypoallergenic, plant-based dairy alternative comprises a step wherein combining the water with a hypoallergenic substrate comprises combining the water with one or more ancient grains (Step 45). In yet another alternative exemplary embodiment, the method for creating a hypoallergenic, plant-based dairy alternative comprises a step wherein combining the water with a hypoallergenic substrate comprises combining the water with a pseudocereal (Step 50). In another alternative exemplary embodiment, the method for creating a hypoallergenic, plant-based dairy alternative comprises a step of combining water with one or more ancient grains (Step 45) and/or one or more pseudocereals (Step 50), and optionally one or more plant-based proteins (Step 47) and/or one or more plant-based soluble fibers (Step 52).

In these exemplary embodiments, the fermented, hypoallergenic, plant-based dairy alternative provides a substrate suitable for use as a base in various food products, including salad dressings. The fermented, hypoallergenic, plant-based dairy alternative can also be used to create non-dairy alternatives for products such as buttermilk or yogurt. Salad dressings, yogurt, and buttermilk are only illustrative examples and other products can be produced from the fermented hypoallergenic, plant-based dairy alternative.

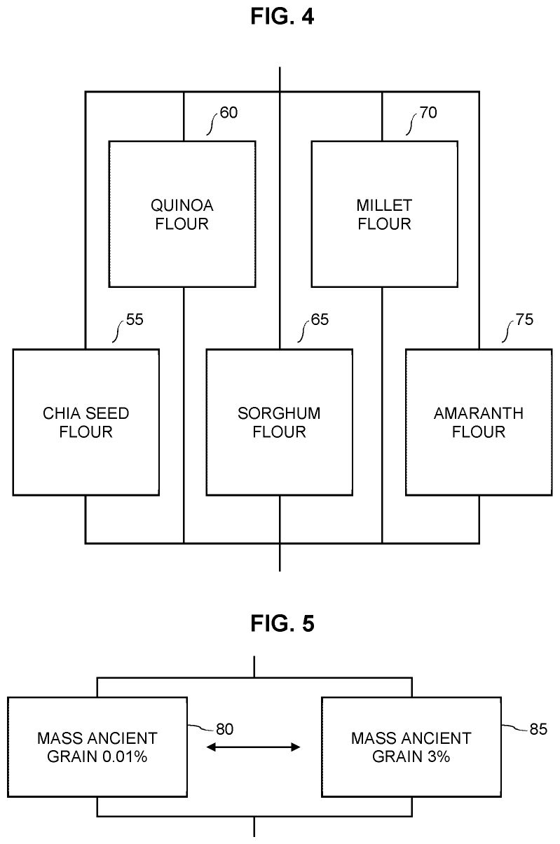

FIG. 4 shows a flow diagram that depicts one alternative method wherein various types of hypoallergenic substrates are combined with water. According to one alternative exemplary method, a step is included for combining a chia seed flour (Step 55) with water. In yet another alternative exemplary embodiment, an included step provides for combining quinoa flour (Step 60) with water. In yet another alternative method, sorghum flour is combined with water (Step 65) in an included step. Millet flour (Step 70) is used in yet an alternative included step for combining water with a hypoallergenic substrate. Amaranth flour (Step 75) is used in yet another alternative included step for combining water with a hypoallergenic substrate. Other potential ancient grains or pseudocereals or flours or extracts thereof include teff, freekeh, farro (emmer), fonio, spelt, chia seeds, hemp hearts, or buckwheat. It should be appreciated that these various types of alternative ingredients, used in corresponding method steps, provide a base that is suitable for fermentation or as a base for other non-dairy, dairy alternatives.

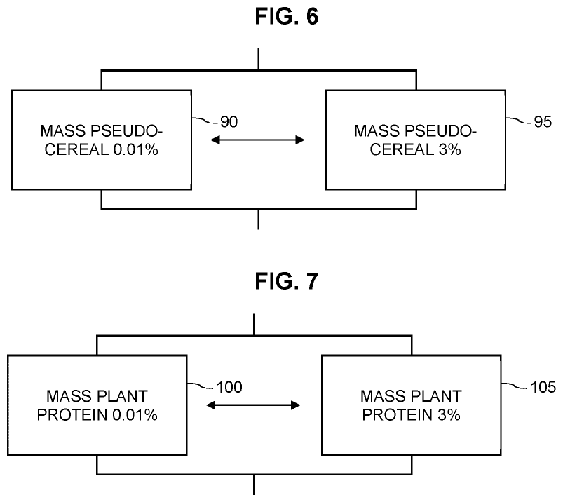

FIG. 5-7 show flow diagrams that depict alternative methods for combining water with a hypoallergenic substrate based on a range of ratios of mass percentages. In one alternative exemplary embodiment, combining water with a hypoallergenic substrate comprises combining with the water an ancient grain in a ratio by mass percentage wherein the mass percentage of the ancient grain is at a minimum of 0.01% of the water (Step 80). Various ratios beginning at 0.01% and running through 3.0% of the mass percentage of water in the mass percentage of an ancient grain (Step 85) is to be included in the methods described herein. In one aspect the water is about 80-98% by mass and the ancient grain is about 0.1-3.0% by mass including all integers and subranges within the specified ranges.

In yet another alternative exemplary embodiment, combining water with a hypoallergenic substrate comprises combining with the water a pseudocereal in a ratio by mass percentage wherein the mass percentage of the pseudocereal is at a minimum of 0.01% of the water (Step 90). Various ratios beginning at 0.01% and running through 3.0% of the mass of water in the mass percentage of a pseudo-cereal (Step 95) is to be included in the methods described herein. In one aspect the water is about 80-98% by mass and the pseudocereal is about 0.1-3.0% by mass including all integers and subranges within the specified ranges.

In another embodiment, the composition comprises a plant-based protein. Accordingly, one alternative method comprises combining water with a plant-based protein in a ratio by mass percentage wherein the mass percentage of the plant-based protein is at a minimum of 0.01% of the water (Step 100). Various ratios beginning at 0.01% and running through 3.0% of the mass percentage of water in the mass percentage of a plant-based protein (Step 105) can be included in the methods described herein. In one aspect the water is about 80-98% by mass and the plant-based protein is about 0.1-3.0% by mass including all integers and subranges within the specified ranges.

In another embodiment, the composition comprises a soluble fiber. In one alternative method comprises adding at least 0.01% (by mass) of soluble fiber to the composition. In one aspect, the method comprises adding up to 3.0% (by mass) of soluble fiber to the composition. In one aspect the water is about 80-98% by mass and the soluble fiber is about 0.1-3.0% by mass including all integers and subranges within the specified range.

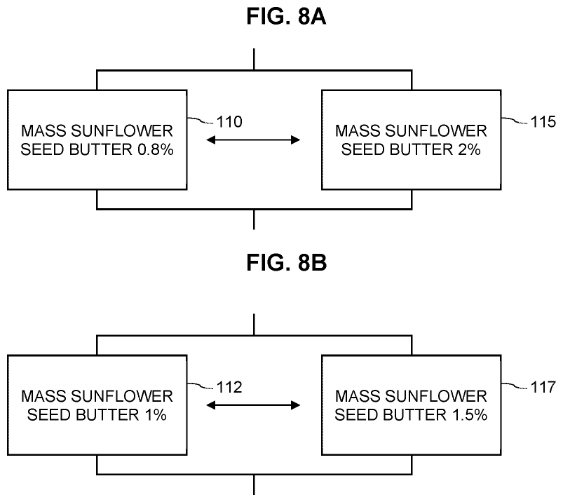

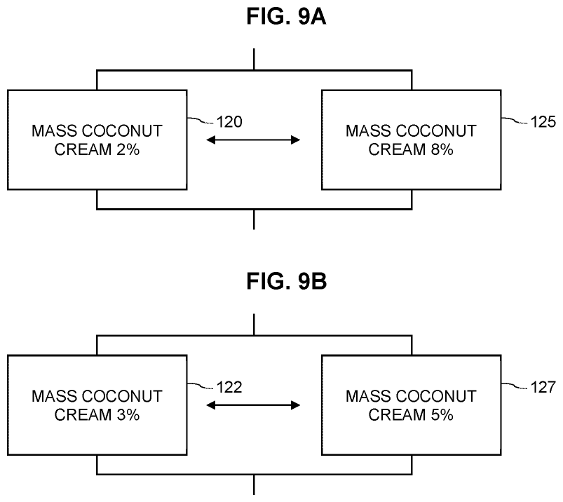

FIG. 8A-9B show flow diagrams that depict alternative methods for combining water with a plant-based butter and/or a cream based on a range of ratios of mass percentages. In one aspect of Step 100, water is combined with a sunflower seed butter at a mass percentage ranging from 0.8% (Step 110) to 2% (Step 115) including all integers and subranges within the specified range. One alternative method provides for combining water with sunflower seed butter in a ratio by mass percentage wherein the mass percentage of the sunflower seed butter is at a minimum of 0.01% of the water. Various ratios beginning at 0.01% and running through 5.0% of the mass percentage of water in the mass percentage of a sunflower seed butter are to be included in the methods described herein. In one aspect of Step 105, water is combined with a sunflower seed butter at a mass percentage ranging from 1% (Step 112) to 1.5% (Step 117) including all integers and subranges within the specified range. According to yet another variation of the present method, various ratios beginning at 4.9% and running through 10.0% of the mass percentage of water in the mass percentage of a sunflower seed butter are to be included in the methods described herein. It should be appreciated that, although a preferred method provides for adding an amount of sunflower seed butter up to 5% of the mass percentage of the water, other variations of the present method are acceptable where the amount of sunflower seed butter combined with the water in an amount of up to 10% of the mass percentage of the water. It should be appreciated that, in these variations of the method, much more stabilizer is required, relative to the preferred methods, to help retard the separation of the sunflower seed butter from the water. In one aspect, the water is about 80-98% by mass and the sunflower seed butter is about 0.8-2.0% by mass including all integers and subranges within the specified range.

In another aspect of Step 100, water is combined with a coconut cream at a mass percentage ranging from 2% (Step 120) to 8% (Step 125) including all integers and subranges within the specified range. One alternative method provides for combining water with coconut cream in a ratio by mass percentage wherein the mass percentage of the coconut cream is at a minimum of 0.01% of the water. Various ratios beginning at 0.01% and running through 5.0% of the mass percentage of water in the mass percentage of a coconut cream are to be included in the methods described herein. In another aspect of Step 105, water is combined with a coconut cream at a mass percentage ranging from 3% (Step 122) to 5% (Step 127). According to yet another variation of the present method, various ratios beginning at 4.9% and running through 10.0% of the mass percentage of water in the mass percentage of a coconut cream are to be included in the methods described herein. It should be appreciated that, although a preferred method provides for adding an amount of coconut cream up to 5% of the mass percentage of the water, other variations of the present method are acceptable where the amount of coconut cream combined with the water in an amount of up to 10% of the mass percentage of the water. It should be appreciated that, in these variations of the method, much more stabilizer is required, relative to the preferred methods, to help retard the separation of the coconut cream from the water. In one aspect, the water is about 80-98% by mass and the sunflower seed butter is about 2-8.0% by mass including all integers and subranges within the specified ranges.

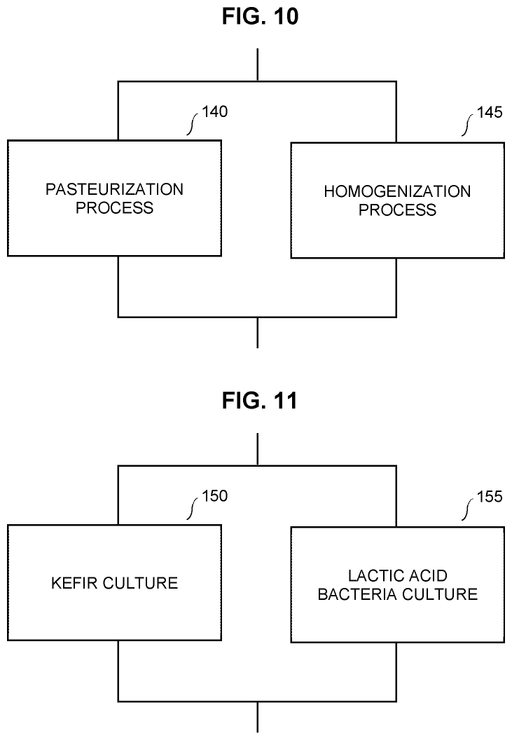

FIG. 10 shows a flow diagram that depicts alternative exemplary methods for subjecting the hypo-allergenic, dairy alternatives to a preservation process. According to one alternative exemplary method, preservation is accomplished by a method step for subjecting the products to a pasteurization process (Step 140). In yet another alternative exemplary method, preservation is accomplished by a method step for subjecting the product to a homogenization process (Step 145).

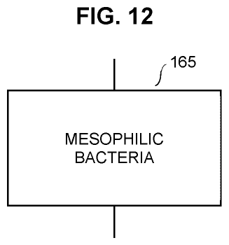

FIG. 11-12 show flow diagrams that depict alternative methods for inoculating a hypoallergenic, dairy alternative. It has been discovered that a hypoallergenic, plant-based substrate can be fermented using lactic acid and other mesophilic bacteria used for making yogurt, buttermilk, or kefir. It has also been discovered that this plant-based substrate can be fermented without the specific addition of a monosaccharide or disaccharide. Accordingly, one alternative exemplary method provides for inoculating the hypoallergenic-slurry with the kefir culture (Step 150). And in yet another alternative exemplary method step, the hypoallergenic slurry is inoculated with a lactic acid bacteria culture (Step 155). And in yet another alternative exemplary method, the hypoallergenic slurry is inoculated with a mesophilic bacteria culture (Step 165).

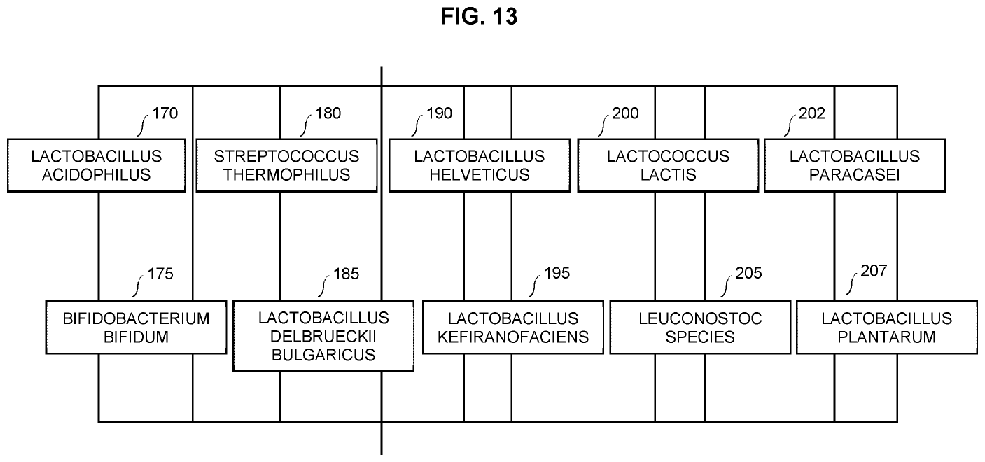

FIG. 13 shows a flow diagram that depicts alternative exemplary methods for inoculating a hypoallergenic slurry with a fermentation agent. According to these various alternative exemplary methods, the included step of inoculating a hypoallergenic slurry comprises inoculating a hypoallergenic slurry with a fermentation agent including at least one or more of Lactobacillus acidophilus (Step 170), Bifidobacterium bifidum (Step 175), Streptococcus thermophilus (Step 180), Lactobacillus delbrueckii bulgaricus (Step 185), Lactobacillus helveticus (Step 190), Lactobacillus kefiranofaciens (Step 195), Lactococcus lactis (Step 200), Leuconostoc species (Step 205), Lactobacillus paracasei (Step 202), Lactobacillus plantarum (Step 207), or combinations thereof. In one aspect the fermentation agent is about 0.001-0.005% by mass of the composition.

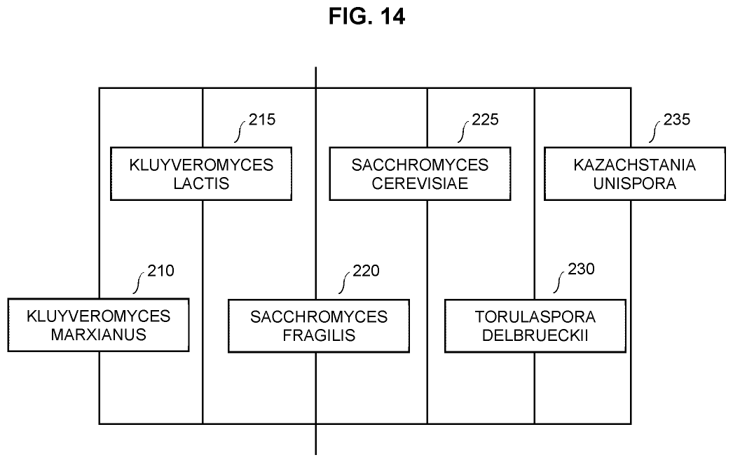

FIG. 14 shows a flow diagram that depicts yet additional alternative exemplary methods for inoculating a hypoallergenic slurry with a fermentation agent. According to these various alternative exemplary methods, the included step of inoculating a hypoallergenic slurry comprises inoculating a hypoallergenic slurry with a fermentation agent including at least one or more of Kluyveromyces marxianus (Step 210), Kluyveromyces lactis (Step 215), Saccharomyces fragilis (Step 220), Saccharomyces cerevisiae (Step 225), Torulaspora delbrueckii (Step 230), Kazachstania unispora (Step 235), or combinations thereof. In one aspect the fermentation agent is about 0.001-0.005% by mass of the composition including all integers and subranges within the specified range.

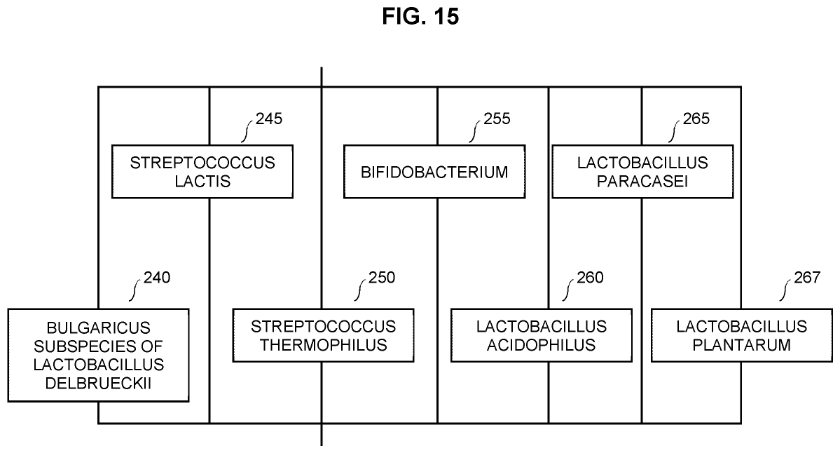

FIG. 15 shows a flow diagram that depicts yet additional alternative exemplary methods for inoculating a hypoallergenic slurry with a fermentation agent. According to these various alternative exemplary methods, the included step of inoculating a hypoallergenic slurry comprises inoculating a hypoallergenic slurry with a fermentation agent including at least one or more of Lactobacillus delbrueckii bulgaricus (Step 240), Streptococcus lactis (Step 245), Streptococcus thermophilus (Step 250), Bifidobacterium (Step 255), Lactobacillus acidophilus (Step 260), Lactobacillus paracasei (Step 265), Lactobacillus plantarum (Step 267), or combinations thereof. In one aspect the fermentation agent is about 0.001-0.005% by mass of the composition, including all integers and subranges within the specified range.

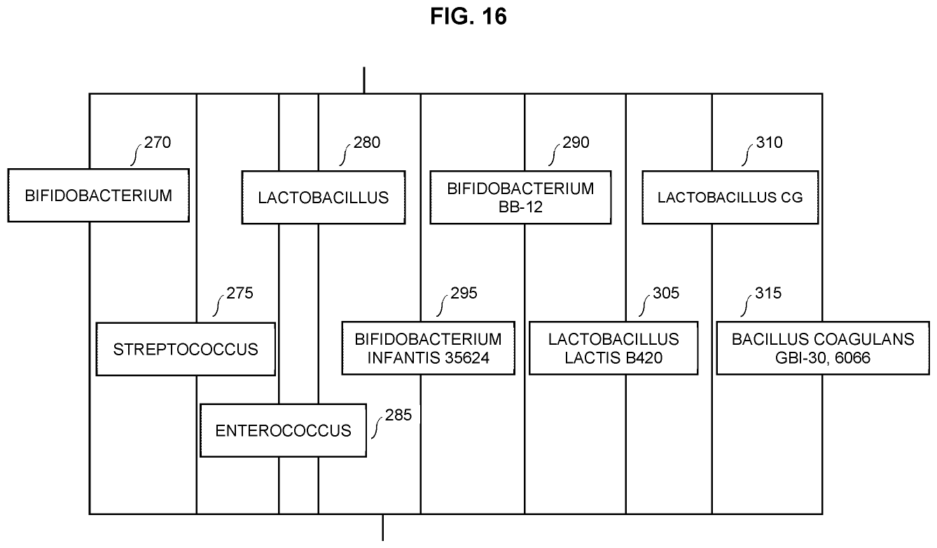

FIG. 16 shows a flow diagram that depicts yet additional alternative exemplary methods for inoculating a hypoallergenic slurry with a probiotic strain. According to these various alternative exemplary methods, the included step of inoculating a hypoallergenic slurry comprises inoculating a hypoallergenic slurry with a probiotic strain including at least one or more of Bifidobacterium (Step 270), Streptococcus (Step 275), Lactobacillus (Step 280), Enterococcus (Step 285), Bifidobacterium BB-12 (Step 290), Bifidobacterium infantis 35624 (Step 295), Lactobacillus lactis B420 (Step 305), Lactobacillus GG (Step 310), Bacillus coagulans GBI-30, 6086 (Step 315), or combinations thereof. In one aspect the probiotic strain is about 0.001-0.005% by mass of the composition.

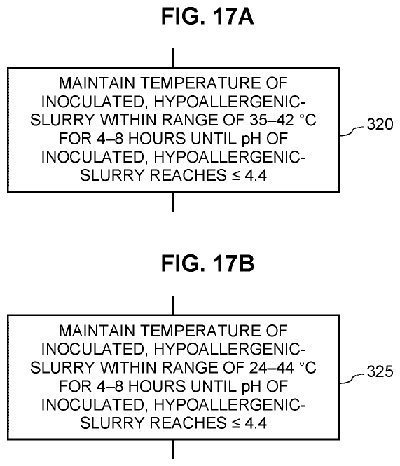

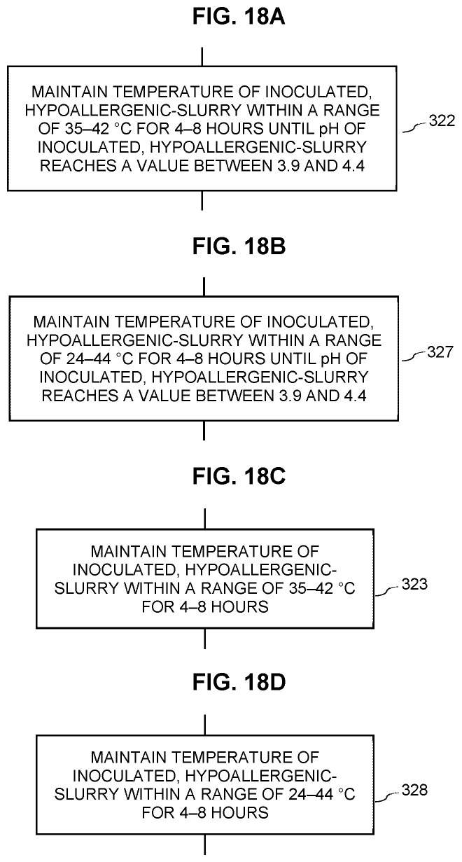

FIG. 17A-18D show flow diagrams that depict alternative methods for adjusting the pH of a hypoallergenic slurry. According to one alternative exemplary method, a step is included for maintaining the temperature of the hypoallergenic slurry within a range substantially between 35-41° C. (95-106° F.) until the pH of the hypoallergenic slurry reaches about 4.4 or lower (Step 320). According yet another alternative exemplary method, a step is included for maintaining the temperature of the hypoallergenic slurry within a range substantially between 23-43° C. (75-110° F.) until the pH of the hypoallergenic slurry reaches about 4.4 or lower (Step 325). In one aspect, the hypoallergenic slurry reaches a pH of about 4.4 or lower in about 6 to about 6.5 hours.

According to other various exemplary methods, a step is included for maintaining the temperature of the hypoallergenic slurry within a range substantially between 35-41° C. (95-106° F.) until the pH of the hypoallergenic slurry reaches a value of about 3.8 to about 4.6, including all integers and end points of this range (Step 322). According yet another alternative exemplary method, a step is included for maintaining the temperature of the hypoallergenic slurry within a range substantially between 23-43° C. (75-110° F.) until the pH of the hypoallergenic slurry reaches a value of 3.9 through 4.6, inclusive of the end points of this range (Step 327). In one aspect, the hypoallergenic slurry reaches a pH of about 3.9-4.4 in about 4 to about 7 hours.

According to other various exemplary methods, a step is included for maintaining the temperature of the hypoallergenic slurry within a range substantially between 35-41° C. (95-106° F.) for an amount of time between 3.9 and 8.1 hours (Step 323). In another alternative method, a step is included for maintaining the temperature of the hypoallergenic slurry within a range substantially between 23-43° C. (75-110° F.) for an amount of time between 3.9 and 8.1 hours (Step 328). In one aspect, the hypoallergenic slurry is maintained at a temperature range substantially between 23-43° C. (75-110° F.) for about 4 to about 6.5 hours.

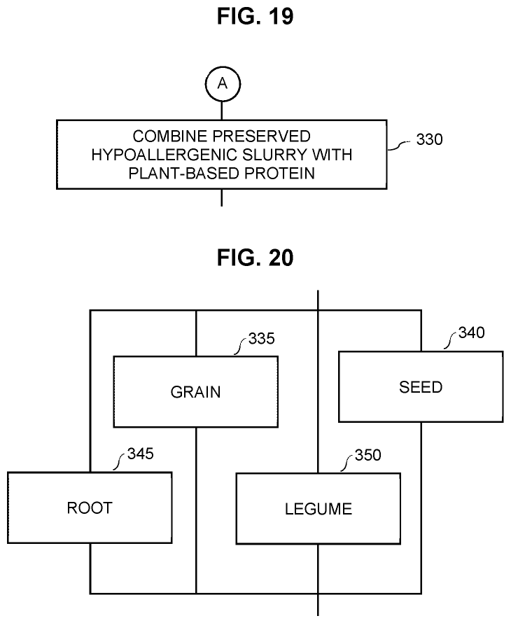

FIG. 19-20 show flow diagrams that depict alternative exemplary methods wherein a plant-based protein is added to a fermented hypoallergenic slurry. It should be appreciated that, according to this alternative exemplary method, an additional included step provides for combining a plant-based protein with a fermented hypoallergenic slurry (Step 330). According to various alternative exemplary methods, the included step for combining a plant-based protein with the fermented hypoallergenic slurry comprises combining at least one or more of a grain (Step 335), a seed (Step 340), a root (Step 345), a legume (Step 350) or combinations thereof as protein sources. Exemplary protein sources include pea protein concentrate, potato protein concentrate, bean protein concentrate, sunflower seed protein concentrate, rapeseed protein or combinations thereof. In addition to or alternatively, fruit and vegetable fiber concentrates or pomaces or combinations thereof can also be added to the fermented hypoallergenic slurry.

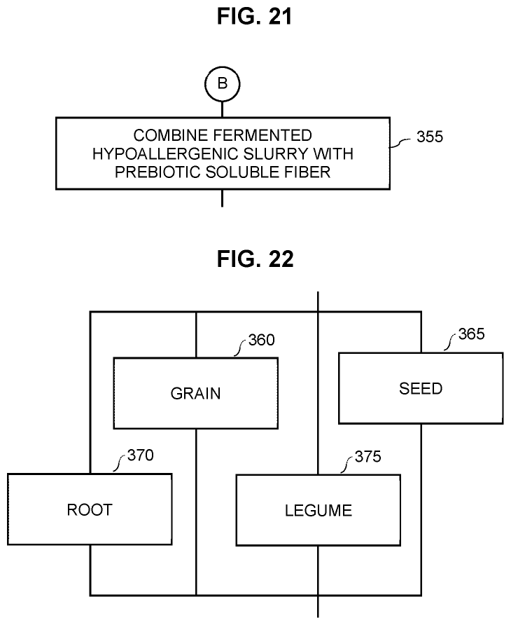

FIG. 21-22 show flow diagrams that depict alternative exemplary methods wherein a prebiotic fiber is added to a fermented hypoallergenic slurry. It should be appreciated that, according to this alternative exemplary method, an additional included step provides for combining a prebiotic soluble fiber with a fermented hypoallergenic slurry (Step 355). According to various alternative exemplary methods, the included step for combining a prebiotic soluble fiber with the fermented hypoallergenic slurry comprises combining at least one or more of a grain (Step 360), a seed (Step 365) a root (Step 370), a legume (Step 375) or combinations thereof as prebiotic soluble fiber sources.

Plant-based buttermilk is one product which may be produced with the hypoallergenic substrate. Buttermilk may be utilized in a number of food products including baked products such as pancakes, waffles, cakes, and biscuits. The tart and tart taste of buttermilk add body and flavor to salad dressings and dips and its natural acidity works with other leavening agents to produce a light finish without adding extra fat.

Traditional buttermilk is a cultured or fermented dairy beverage typically made from pasteurized or ultra-pasteurized low-fat or skim milk with nonfat dry milk solids added. It can be made from several other dairy ingredients including but not limited to liquid whey, goat milk, sheep milk and buffalo milk. For these reasons, it would be desirable to have a dairy-free, nut-free buttermilk substitute. Such a buttermilk substitute is available utilizing the method and composition of the hypoallergenic-substrate disclosed above.

The use of buttermilk powder instead of fluid buttermilk has certain advantages. The use of buttermilk powder instead of fluid buttermilk makes transportation and storage easy. The removal of moisture from buttermilk inhibits microbial growth and increases shelf life.

Buttermilk powder also brings several desirable properties to food formulations, such as contributing flavor notes from sweet to sour.

Powdered buttermilk is primarily made from low fat milk, skim milk or liquid whey that has been concentrated by evaporation, dried to a target moisture content, and made flowable and liquid dispersible by industrial drying processes such as but not limited to spray drying, freeze drying, drum drying, pulse drying, freeze drying and agglomeration. Some of these processes are used in combination, for example, spray drying followed by agglomeration. Some of these processes require additional milling to the achieve the correct particle size after drying to provide improved product flow and liquid dispersibility characteristics.

The simplest commercial versions of buttermilk powders are labeled as buttermilk solids. Other versions are blends of buttermilk solids, whey solids and other ingredients.

Embodiments of the present invention utilize the “hypoallergenic substrate” to form a plant-based powder for making a non-dairy, nut-free buttermilk substitute. Table 3 compares the nutritional composition of liquid and powdered buttermilk with the nutritional composition of a plant-based buttermilk produced utilizing the method and composition of the hypoallergenic-substrate applications. Table 3 also shows the nutritional composition of a plant-based buttermilk powder produced through the process of the present disclosure. The hypoallergenic, plant-based buttermilk was designed to be approximately 1-2% fat, 0.3-0.8% protein and 0.1-0.3% sugar on a liquid basis. This allowed end users to enjoy the acidic properties of buttermilk without lactose which is poorly digested by 68% of the world population or simple sugars that contribute to diabetes and obesity.

TABLE 3
The Nutritional Composition of Typical Liquid and Powdered Buttermilk

| | Moisture | Fat | Protein | Carbohydrate | Ash |
|---|---|---|---|---|---|
| Product | (%) | (%) | (%) | (%) | (%) |
| Buttermilk Liquid | 87.9 | 3.3 | 3.2 | 4.9* | 0.7 |
| Buttermilk Powder | 3.0-3.5 | 5.5-6.0 | 32.0-34.5 | 49.5-50.5* | 7.5-8.0 |
| Plant Based Buttermilk | 93 | 1.0-2.0 | 0.3-0.8 | 0.1-0.3 | n/a |
| Plant Based Buttermilk | 1.5 | 61.5-64.5 | 19.5-24.5 | 6.5-9.0 | 6.5-7.0 |
| Powder | | | | | |

*The carbohydrate in liquid and powdered buttermilk is lactose, a disaccharide composed of glucose bonded to galactose.

This nutritional composition of the plant-based buttermilk can be enhanced to create a functional plant-based buttermilk powder. It can be blended with a variety of plant-based nut, grain, legume, root and seed powders to enhance protein, fat, carbohydrates and other ingredients including one or more of almond, cashew, walnut, macadamia, pistachio, coconut, oat, quinoa, oat, amaranth, green pea, yellow pea, lentil, red bean, black bean, kidney bean, navy bean, chickpea, sunflower seed, sesame seed, hemp seed, pumpkin seed, flax seed, or chia seed.

To achieve a flowable and liquid dispersible plant-based buttermilk powder, bulking agents such as long chain maltodextrins, anti-caking agents such as sodium silicate and emulsifying agents such as powdered sunflower lecithin can be used.

In a first formula, a protein source at 5% to 15% total protein is added to the hypoallergenic substrate after drying, and a flow agent, an anticaking agent and an emulsifying agent are added as needed to the liquid buttermilk prior to the drying process.

In a second formula, a protein source at 5% to 15% total protein and a fiber source at 5 to 15% total fiber are added to the hypoallergenic substrate after drying, and a flow agent, an anticaking agent and an emulsifying agent are added as needed to the liquid buttermilk prior to the drying process.

The first method comprises adding plant-based proteins, fats, carbohydrates, and other ingredients to the hypoallergenic substrate disclosed above prior to the drying process. Addition of these ingredients will allow the addition of nutritional and/or functional benefits to the cultured buttermilk as needed.

A second method comprises the addition of plant-based proteins, fats, carbohydrates, and other ingredients to the liquid cultured buttermilk at the drying facility but prior to the drying process. Addition of these ingredients will allow the addition of nutritional and/or functional benefits to the cultured buttermilk as needed.

A third method comprises the addition of plant-based proteins, fats, carbohydrates, and other ingredients to the plant-based buttermilk powder after it is in dried powder form. These ingredients can then be blended together or blended and then agglomerated with industrial powder blenders including but not limited to ribbon, V, or tumble blenders. Blending followed by agglomeration will allow addition of heat sensitive ingredients after drying and creating a particle that disperses well in liquids and blends well with other powders like but not limited to biscuit and cake mixes. The latter method is preferred due to its relative simplicity.

A fourth method comprises combining a dried plant-based dairy alternative substrate and one or more of dried starches or fibers; fats; hydrocolloids, texturizers, or stabilizers; plant-based emulsifiers; acidulants to form a dry admixture. The dried plant-based dairy alternative substrate can be prepared as described herein and then combined with dried fibers, fats, hydrocolloids, texturizers, or stabilizers, plant-based emulsifiers, acidulants, or combinations thereof. These may be prepared in house or obtained in dry formats.

### Applications

The resulting dried buttermilk powder may be used as one or more of a flavor, color, texture, moisture, or leavening agent in baked goods including but not limited to biscuits, pancakes, breads, cakes, and pastries.

The resulting dried buttermilk power may be used to impart flavor, acidity, texture, or creaminess to liquid or semi-solid goods including but not limited to soups, sauces, custards, salad dressings and dips.

The resulting dried buttermilk powder may be used as a coating or rub for fried or grilled meats and vegetables as a flavoring and tenderizing agent.

The use of the disclosed hypoallergenic, plant-based cultured buttermilk powder allows home and industrial use of a dairy free version of powdered buttermilk in the food product applications described above.

One embodiment described herein is a powdered or concentrated composition comprising: 30-90% by mass of cultured hypoallergenic substrate; 5-10% by mass of one or more plant-based proteins; and 10-50% by mass of one or more starches or fibers. In one aspect, the composition further comprises one or more of: 5-10% by mass of one or more fats; 1-5% by mass of one or more hydrocolloids, texturizers, or stabilizers; 1-5% by mass of one or more plant-based emulsifiers; 1-5% by mass of one or more acidulants. In another aspect, the cultured hypoallergenic substrate comprises: 0.1-3.0% by mass of one or more plant-based carbohydrate sources; 0.8-10% by mass of one or more plant seed butters or creams; 0.1-0.75% by mass of one or more plant-based texturizers or stabilizers; 80-98% by mass of one or more solvents; and 0.001-0.005% by mass of one or more microorganism cultures. In another aspect, the one or more plant-based carbohydrate sources comprises millet, sorghum, quinoa, oat, amaranth, einkorn, teff, freekeh, farro (emmer), fonio, spelt, chia seeds, hemp hearts, buckwheat, or combinations thereof. In another aspect, the one or more plant seed butters or creams comprises sunflower seed butter, coconut cream, pumpkin seed butter, watermelon seed butter, hemp seed butter, chia seed butter, flax seed butter, poppy seed butter, or combinations thereof. In another aspect, the one or more plant-based texturizers or stabilizers comprises one or more of guar gum, locust bean gum, gellan gum, xanthan gum, acacia gum, tragacanth gum, pectin, agar, or combinations thereof. In another aspect, the one or more solvents comprise water. In another aspect, the one or more microorganism cultures comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, Torulaspora delbrueckii, or combinations thereof. In another aspect, the one or more plant-based proteins comprises pea protein concentrate, potato protein concentrate, bean protein concentrate, sunflower seed protein concentrate, rapeseed protein, or combinations thereof. In another aspect, the one or more one or more starches comprise hypoallergenic maltodextrin, food starch, modified food starch, or combinations thereof; and the one or more fibers comprise fruit or vegetable soluble fiber concentrates, pomaces, or combinations thereof. In another aspect, the one or more fats comprises one or more of plant-based oils, butters, or creams, including those from sunflower seed, pumpkin seed, watermelon seed, hemp seed, chia seed, flax seed, poppy seed, coconut cream, or combinations thereof. In another aspect, the one or more hydrocolloids, texturizers, or stabilizers comprises one or more of guar gum, locust bean gum, gellan gum, xanthan gum, acacia gum, tragacanth gum, pectin, agar, or combinations thereof. In another aspect, the one or more plant-based emulsifiers comprises one or more of sunflower lecithin, mono and diglycerides, or combinations thereof. In another aspect, the one or more one or more acidulants comprises citric acid, acetic acid, phosphoric acid, fumaric acid, malic acid, tartaric acid, lactic acid, or combinations thereof. In another aspect, the cultured hypoallergenic substrate comprises: 0.1-3.0% by mass of a flour from one or more of millet, sorghum, quinoa, oat, amaranth, einkorn, teff, freekeh, farro (emmer), fonio, spelt, chia seeds, hemp hearts, buckwheat, or combinations thereof; 0.8-10% by mass of one or more of sunflower seed butter, coconut cream, pumpkin seed butter, watermelon seed butter, hemp seed butter, chia seed butter, flax seed butter, poppy seed butter, or combinations thereof; 0.1-0.75% by mass of one or more of guar gum, locust bean gum, gellan gum, xanthan gum, acacia gum, tragacanth gum, pectin, agar, or combinations thereof; 80-98% by mass of water; and 0.001-0.005% by mass of one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, Torulaspora delbrueckii, or combinations thereof. In another aspect, the cultured hypoallergenic substrate comprises: 0.1-3.0% by mass of a flour from millet, sorghum, or combinations thereof; 0.8-10% by mass of sunflower seed butter, coconut cream, or combinations thereof; 0.1-0.75% by mass of one or more of guar gum, locust bean gum, gellan gum, xanthan gum, or combinations thereof; 80-98% by mass of water; and 0.001-0.005% by mass of one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof. In another aspect, the cultured hypoallergenic substrate comprises: 0.2-0.8% by mass of a flour from millet, sorghum, or combinations thereof; 1.0-1.5% by mass of sunflower seed butter; 3.0-5.0% by mass of coconut cream; 0.2-0.5% by mass of one or more of guar gum, locust bean gum, gellan gum, xanthan gum, or combinations thereof; 92-95% by mass of water; and 0.002-0.004% by mass of one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof. In another aspect, the powdered or concentrated composition is vegan, hypoallergenic, and contains no added monosaccharides or disaccharides.

Another embodiment described herein is a method for manufacturing a concentrated cultured plant-based dairy alternative, the method comprising: combining to form a hypoallergenic slurry: one or more hypoallergenic-substrates comprising ancient grains or pseudo-cereals; sunflower seed butter and coconut cream; one or more stabilizers; and water; pasteurizing and homogenizing the hypoallergenic-slurry to form a pasteurized, homogenized hypoallergenic-slurry; inoculating the pasteurized, homogenized hypoallergenic-slurry with one or more fermentation agents and fermenting for about 4 to 8 hours until the pH is about 4.4 or lower to form a fermented hypoallergenic-slurry; and increasing percent solids of the fermented hypoallergenic-slurry using one or more of reverse osmosis, nanofiltration, mechanical vapor recompression, or combinations thereof to form the concentrated cultured plant-based dairy alternative. In one aspect, the ancient grains or pseudo-cereals comprise one or more of flour from millet and sorghum. In another aspect, the stabilizers comprise one or more of locust bean gum, gellan gum, and xanthan gum. In another aspect, the hypoallergenic-slurry comprises a ratio by weight of: the hypoallergenic-substrates being 0.01% to 3.0% of the weight of the water; and the sunflower seed butter and coconut cream being 0.01% to 5.0% of the weight of the water. In another aspect, the ratio by weight of the sunflower seed butter is 4.9% to 10.0% of the weight of the water. In another aspect, the ratio by weight of the coconut cream is 4.9% to 10.0% of the weight of the water. In another aspect, the fermentation agent comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, and Torulaspora delbrueckii. In another aspect, one or more of starches or fibers; fats; hydrocolloids, texturizers, or stabilizers; plant-based emulsifiers; acidulants, or combinations thereof are added to the fermented hypoallergenic-slurry prior to increasing percent solids.

Another embodiment described herein is a method for manufacturing a powdered cultured plant-based dairy alternative, the method comprising: combining to form a hypoallergenic slurry: one or more hypoallergenic-substrates comprising ancient grains or pseudo-cereals; sunflower seed butter and coconut cream; one or more stabilizers; and water; pasteurizing and homogenizing the hypoallergenic-slurry to form a pasteurized, homogenized hypoallergenic-slurry; inoculating the pasteurized, homogenized hypoallergenic-slurry with one or more fermentation agents and fermenting for about 4 to 8 hours until the pH is about 4.4 or lower to form a fermented hypoallergenic-slurry; and drying the fermented hypoallergenic-slurry to form the powdered cultured plant-based dairy alternative. In one aspect, drying comprises spray drying, freeze drying, drum drying, pulse drying, or combinations thereof. In another aspect, the method further comprises agglomerating the powdered cultured plant-based dairy alternative. In another aspect, the ancient grains or pseudo-cereals comprise one or more of flour from millet or sorghum. In another aspect, the stabilizers comprise one or more of guar gum, locust bean gum, gellan gum, or xanthan gum. In another aspect, the hypoallergenic-slurry comprises a ratio by weight of: the hypoallergenic-substrates being 0.01% to 3.0% of the weight of the water; and the sunflower seed butter and coconut cream being 0.01% to 5.0% of the weight of the water. In another aspect, the ratio by weight of the sunflower seed butter is 4.9% to 10.0% of the weight of the water. In another aspect, the ratio by weight of the coconut cream is 4.9% to 10.0% of the weight of the water. In another aspect, the fermentation agent comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, and Torulaspora delbrueckii. In another aspect, one or more of starches or fibers; fats; hydrocolloids, texturizers, or stabilizers; plant-based emulsifiers; acidulants, or combinations thereof are added to the fermented hypoallergenic-slurry prior to drying.

Another embodiment described herein is a method for manufacturing a powdered or concentrated cultured plant-based dairy alternative, the method comprising: combining a plant-based dairy alternative substrate and one or more starches or fibers; fats; hydrocolloids, texturizers, or stabilizers; plant-based emulsifiers; acidulants, or combinations thereof to form to form a mixture; and concentrating or drying the mixture. In one aspect, drying comprises spray drying, freeze drying, drum drying, pulse drying, or combinations thereof. In another aspect, the method further comprises agglomerating the powdered cultured plant-based dairy alternative. In another aspect, the plant-based dairy alternative substrate is manufactured by: combining and blending one or more plant-based carbohydrate sources, one or more plant seed butters or creams, one or more plant-based texturizers or stabilizers, and one or more solvents to form a blended composition; pasteurizing the blended composition; homogenizing the blended composition to form a homogenized composition; cooling the homogenized composition; adding one or more microorganism cultures to the cooled, homogenized composition; fermenting the composition until the pH is about 4.4 or lower; and cooling the fermented composition to about 4° C.

Another embodiment described herein is a method for manufacturing a powdered or concentrated cultured plant-based dairy alternative, the method comprising: providing a plant-based dairy alternative substrate; drying the plant-based dairy alternative substrate; combining the dried plant-based dairy alternative substrate with one or more starches or fibers; fats; hydrocolloids, texturizers, or stabilizers; plant-based emulsifiers; acidulants to form a blend; and agglomerating the blend. In one aspect, the plant-based dairy alternative substrate is manufactured by: combining and blending one or more plant-based carbohydrate sources, one or more plant seed butters or creams, one or more plant-based texturizers or stabilizers, and one or more solvents to form a blended composition; pasteurizing the blended composition; homogenizing the blended composition to form a homogenized composition; cooling the homogenized composition; adding one or more microorganism cultures to the cooled, homogenized composition; fermenting the composition until the pH is about 4.4 or lower; and cooling the fermented composition to about 4° C.

Another embodiment described herein is a method for manufacturing a powdered or concentrated cultured plant-based dairy alternative, the method comprising: combining a dried plant-based dairy alternative substrate and one or more of dried starches or fibers; fats; hydrocolloids, texturizers, or stabilizers; plant-based emulsifiers; acidulants to form a dry admixture. In one aspect, drying comprises spray drying, freeze drying, drum drying, pulse drying, or combinations thereof. In another aspect, the method further comprises agglomerating the powdered cultured plant-based dairy alternative. In another aspect, the dried plant-based dairy alternative substrate is manufactured by: combining and blending one or more plant-based carbohydrate sources, one or more plant seed butters or creams, one or more plant-based texturizers or stabilizers, and one or more solvents to form a blended composition; pasteurizing the blended composition; homogenizing the blended composition to form a homogenized composition; cooling the homogenized composition; adding one or more microorganism cultures to the cooled, homogenized composition; fermenting the composition until the pH is about 4.4 or lower; cooling the fermented composition to about 4° C.; and drying the fermented composition to form the dried plant-based dairy alternative substrate.

The components may be blended with ribbon mixers, tumble mixers, or other mixers known in the industry. The resulting blend may be evaporated or dried to a target moisture content by methods known in the art such as spray drying, freeze drying, drum drying, pulse drying, and the like. Following drying, the blend may be agglomerated by methods known in the art. Drying and agglomeration may provide better blending and incorporation of the cultured plant-based dairy alternative into other food applications. Some of these processes are used in combination, for example, spray drying followed by agglomeration. Some of these processes require additional milling to the achieve the correct particle size after drying to provide improved product flow and liquid dispersibility characteristics.

Another embodiment described herein is a composition manufactured by any of the methods described herein.

It will be apparent to one of ordinary skill in the relevant art that suitable modifications and adaptations to the compositions, formulations, methods, processes, and applications described herein can be made without departing from the scope of any embodiments or aspects thereof. The compositions and methods provided are exemplary and are not intended to limit the scope of any of the specified embodiments. All of the various embodiments, aspects, and options disclosed herein can be combined in any variations or iterations. The scope of the compositions, formulations, methods, and processes described herein include all actual or potential combinations of embodiments, aspects, options, examples, and preferences herein described. The exemplary compositions and formulations described herein may omit any component, substitute any component disclosed herein, or include any component disclosed elsewhere herein. The ratios of the mass of any component of any of the compositions or formulations disclosed herein to the mass of any other component in the formulation or to the total mass of the other components in the formulation are hereby disclosed as if they were expressly disclosed. Should the meaning of any terms in any of the patents or publications incorporated by reference conflict with the meaning of the terms used in this disclosure, the meanings of the terms or phrases in this disclosure are controlling. Furthermore, the foregoing discussion discloses and describes merely exemplary embodiments. All patents and publications cited herein are incorporated by reference herein for the specific teachings thereof.

### EXAMPLES

### Example 1

A plant-based dairy alternative composition was prepared comprising the following components shown in Table 4. In one aspect, the plant-based dairy alternative can be used as a buttermilk alternative. Alternative uses are for the preparation of yogurt or kefir. In another aspect, the plant-based dairy alternative can be used as the substrate for powdered, concentrated, or agglomerated dairy alternatives.

TABLE 4
Exemplary Plant-Based Dairy Alternative Composition

| Component | Mass Percentage (%) |
|---|---|
| Millet and sorghum flours | 0.2-0.8 |
| Sunflower seed butter | 1-1.5 |
| Coconut cream | 3-5 |
| Guar gum, locust bean gum, | 0.2-0.5 |
| gellan gum, and/or xanthan gum | |
| Water | 92-95 |
| Microorganism cultures | 0.002-0.004 |

The microorganism cultures comprised at least one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof.

The composition was prepared by combining all components except the microorganism cultures into a high-shear mixer, blending the batch at high shear until it is smooth, and the gums were dispersed, and no clumps were formed. The composition was transferred to a batch kettle and mixed with gentle agitation until the pasteurization/homogenization steps. Prior to pasteurization, the composition was preheated to 40-48° C. (107-117° F.). Pasteurization was performed at 93° C. (200° F.) followed by homogenization at 93° C. (200° F.), 500/1500 psi for 7 minutes. Following pasteurization/homogenization, the mixture was cooled to about 40° C. (106° F.). The microorganism cultures were added, mixed, and the composition was allowed to ferment at ˜40° C. (106° F.) for about 5-8 hours or until the pH reached 4.4 or lower. See FIG. 23. Following culturing, the composition was transferred to a cooling tank and held at 4° C. (39° F.).

Developers of commercial cultured products made from plant-based ingredients have struggled to reduce culturing times to those similar to cultured dairy products which are typically 6 to 8 hours. They have had to resort to adding monosaccharides and disaccharides to reduce these culturing times. Even with the addition of monosaccharides and disaccharides, these culturing times still typically exceed those of cultured dairy products. The advantage of the compositions and method described herein is the addition of a small amount, 0.1-3.0%, of ancient grain flours, without adding supplemental monosaccharides or disaccharides, that enhances the culturing times of the plant-based dairy alternatives described herein to be similar to those of cultured dairy products. See FIG. 23.

### Example 2

Five powdered or concentrated plant-based buttermilk alternative compositions were prepared comprising the components shown in Tables 5-9.

TABLE 5
Plant-Based Buttermilk Composition A

| Component | Mass Percentage (%) |
|---|---|
| Cultured Hypoallergenic Substrate | 65-85 |
| Plant Based Protein - Suntein | 5-10 |
| Maltodextrin - M150 | 10-25 |

TABLE 6
Plant-Based Buttermilk Composition B

| Component | Mass Percentage (%) |
|---|---|
| Cultured Hypoallergenic Substrate | 37-84 |
| Plant Based Protein - Suntein | 5-10 |
| Maltodextrin - M150 | 10-50 |
| Hydrocolloid - Guar gum and/or locust bean gum | 1-3 |

TABLE 7
Plant-Based Buttermilk Composition C

| Component | Mass Percentage (%) |
|---|---|
| Cultured Hypoallergenic Substrate | 35-68 |
| Plant Based Protein - Suntein | 5-10 |
| Maltodextrin - M150 | 25-50 |
| Emulsifier - Sunflower Lecithin | 2-5 |

TABLE 8
Plant-Based Buttermilk Composition D

| Component | Mass Percentage (%) |
|---|---|
| Cultured Hypoallergenic Substrate | 35-68 |
| Plant Based Protein - Suntein | 5-10 |
| Modified Food Starch - Mira-Cap. Mira-Mist | 25-50 |
| Emulsifier - Sunflower Lecithin | 2-5 |

TABLE 9
Plant-Based Buttermilk Composition E

| Component | Mass Percentage (%) |
|---|---|
| Cultured Hypoallergenic Substrate | 32-67 |
| Plant Based Protein - Suntein | 5-10 |
| Modified Food Starch - Mira-Cap. Mira-Mist | 25-50 |
| Emulsifier - Sunflower Lecithin | 2-5 |
| Hydrocolloid - Guar gum and/or locust bean gum | 1-3 |

The cultured hypoallergenic substrate used in the compositions shown in Tables 5-9 was manufactured as described in Example 1. Briefly, the substrate was formed by combining and blending the one or more plant-based carbohydrate sources; the one or more plant seed butters or creams; the one or more plant-based texturizers or stabilizers; and water; pasteurizing the blended composition; homogenizing the blended composition; cooling the homogenized composition; adding the one or more microorganism cultures to the blended, pasteurized, homogenized, and cooled composition; fermenting the composition until the pH is about 4.4 or lower; and cooling the fermented composition to about 4° C. The microorganism cultures comprised at least one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof.

Prior to pasteurization, the composition was preheated to 40-48° C. (107-117° F.). Pasteurization was performed at 93° C. (200° F.) followed by homogenization at 93° C. (200° F.), 500/1500 psi for 7 minutes. Following pasteurization/homogenization, the mixture was cooled to about 40° C. (106° F.). The microorganism cultures were added and mixed and the composition was allowed to ferment at ˜40° C. (106° F.) for about 5-8 hours or until the pH reached 4.4 or lower. See FIG. 23. Following culturing, the composition was transferred to a cooling tank and held at 4° C. (39° F.).

Concentrated or powdered compositions can be manufactured by the following methods.

A first method for manufacturing a powdered or concentrated cultured plant-based dairy alternative includes adding plant-based proteins such as pea protein, potato protein, bean protein, sunflower seed protein, rapeseed protein or combinations thereof; fats such as plant-based butters or creams, including sunflower seed, pumpkin seed, watermelon seed, hemp seed, chia seed, flax seed, poppy seed, coconut cream, or combinations thereof; carbohydrates such as ancient grain flours including millet, sorghum, quinoa, oat, amaranth, teff, freekeh, farro (emmer), fonio, spelt, chia seeds, hemp hearts, buckwheat, or combinations thereof; and other ingredients such as texturizers, stabilizers, prebiotic soluble plant fibers, emulsifiers, hydrocolloids, and/or solvents to the plant-based dairy alternative substrate disclosed above prior to the drying process. The mixture is then dried or evaporated.

A second method for manufacturing a powdered or concentrate cultured plant-based dairy alternative includes adding plant-based proteins such as pea protein, potato protein, bean protein, sunflower seed protein, rapeseed protein or combinations thereof; fats such as plant-based butters or creams, including sunflower seed, pumpkin seed, watermelon seed, hemp seed, chia seed, flax seed, poppy seed, coconut cream, or combinations thereof; carbohydrates such as ancient grain flours including millet, sorghum, quinoa, oat, amaranth, teff, freekeh, farro (emmer), fonio, spelt, chia seeds, hemp hearts, buckwheat, or combinations thereof; and other ingredients such as texturizers, stabilizers, prebiotic soluble plant fibers, emulsifiers, hydrocolloids, and/or solvents to the cultured plant-based dairy alternative substrate at the drying facility but prior to the drying process.

A third method for manufacturing a powdered or concentrated cultured plant-based dairy alternative includes adding plant-based proteins such as pea protein, potato protein, bean protein, sunflower seed protein, rapeseed protein or combinations thereof; fats such as plant-based butters or creams, including sunflower seed, pumpkin seed, watermelon seed, hemp seed, chia seed, flax seed, poppy seed, coconut cream, or combinations thereof; carbohydrates such as ancient grain flours including millet, sorghum, quinoa, oat, amaranth, teff, freekeh, farro (emmer), fonio, spelt, chia seeds, hemp hearts, buckwheat, or combinations thereof; and other ingredients such as texturizers, stabilizers, prebiotic soluble plant fibers, emulsifiers, hydrocolloids, and/or solvents to the cultured plant-based dairy alternative powder after it is in dried powder form. These ingredients are blended together or blended and then agglomerated with industrial powder blenders such as ribbon, V, or tumble blenders. When the ingredients are blended followed by agglomeration, heat sensitive ingredients will be added after drying. The particles formed from this method will be dispersed in liquids and/or blended with other powders such as biscuit and cake mixes.

A fourth method for manufacturing a powdered or concentrated cultured plant-based dairy alternative includes combining dry ingredients to form the composition. The following plant-based, non-allergic dry ingredients are used to form the cultured plant-based dairy alternative: maltodextrin, natural or modified starches, fibers, proteins, and acidulants that may or may not be encapsulated. Acidulants can include but are not limited to citric acid, acetic acid, phosphoric acid, fumaric acid, malic acid, tartaric acid, and lactic acid. The choice of acidulant will depend on their source, flavor profile, and application compatibility.

The cultured hypoallergenic plant slurry is concentrated by itself or with the added maltodextrins, starches, fibers, and proteins involved in the spray drying process. The first step in the slurry concentration will involve increasing the percent solids from around 3-10% solids to 18-25% using reverse osmosis (RO) or a combination of RO and nanofiltration (NF). With percent solids above 25-30%, it is more economical to use mechanical vapor recompression (MVR) evaporation to further concentrate the slurry. Utilizing MVR in this second step will increase percent solids from as low as 20% to 45-65%.

Powdered compositions were be manufactured by the following methods. A powdered plant-based blend can be formulated by adding the following plant-based, non-allergic dry ingredients: maltodextrin, natural or modified starches, fibers, proteins, and acidulants (encapsulated or not). This can be blended with ribbon mixers, tumble mixers, or other mixers known to the industry. The resulting blend can be spray dried and agglomerated to provide better blending and incorporation into other food applications. Acidulants can include but are not limited to citric acid, acetic acid, phosphoric acid, fumaric acid, malic acid, tartaric acid, lactic acid, or combinations thereof. The choice of acidulant will depend on their source, flavor profile, or application compatibility. The acidulant can be encapsulated to prevent it from acting too quickly. Carbohydrates such as starches and fibers may include, but are not limited to, ancient grain flours including millet, sorghum, quinoa, oat, amaranth, teff, freekeh, farro (emmer), fonio, spelt, chia seeds, hemp hearts, buckwheat, fruit and vegetable fibers, pomaces, or combinations thereof. Proteins may include, but are not limited to, plant-based proteins such as pea protein, potato protein, bean protein, sunflower seed protein, rapeseed protein, or combinations thereof.

Preparation of the powdered plant-based buttermilk alternative compositions using spray drying produced the following results. Composition A (Table 5) resulted in less than 5% yield and the composition stuck to the spray drier. Preparation of the powdered plant-based buttermilk alternative composition using Composition B (Table 6) resulted in a 15% yield and the composition stuck to the spray drier. Preparation of the powdered plant-based buttermilk alternative composition using Composition C (Table 7) resulted in a 30% yield and the composition stuck to the spray drier. Preparation of the powdered plant-based buttermilk alternative composition using Composition D (Table 8) resulted in a 30% yield and the composition stuck to the spray drier. Preparation of the powdered plant-based buttermilk alternative composition using Composition E (Table 9) resulted in a 30% yield and slightly less of the composition stuck to the spray drier as compared to the other compositions. Composition E was used as the starting point for further testing using synthetic emulsifiers such as DATEM (diacetyl tartaric acid ester of mono- and diglycerides) and other modified food starches including Pure-Cote® (Grain Processing Corporation; modified corn starch), or Capsul® (Ingredion; modified food starch derived from waxy maize).

1. A powdered or concentrated composition comprising:
30-90% by mass of cultured hypoallergenic substrate;
5-10% by mass of one or more plant-based proteins; and
10-50% by mass of one or more starches or fibers.

2. The composition of claim 1, wherein the composition further comprises one or more of:
5-10% by mass of one or more fats;
1-5% by mass of one or more hydrocolloids, texturizers, or stabilizers;
1-5% by mass of one or more plant-based emulsifiers;
1-5% by mass of one or more acidulants.

3. The composition of claim 1, wherein the cultured hypoallergenic substrate comprises:
0.1-3.0% by mass of one or more plant-based carbohydrate sources;
0.8-10% by mass of one or more plant seed butters or creams;
0.1-0.75% by mass of one or more plant-based texturizers or stabilizers;
80-98% by mass of one or more solvents; and
0.001-0.005% by mass of one or more microorganism cultures.

4. The composition of claim 3, wherein the one or more plant-based carbohydrate sources comprises millet, sorghum, quinoa, oat, amaranth, einkorn, teff, freekeh, farro (emmer), fonio, spelt, chia seeds, hemp hearts, buckwheat, or combinations thereof.

5. The composition of claim 3, wherein the one or more plant seed butters or creams comprises sunflower seed butter, coconut cream, pumpkin seed butter, watermelon seed butter, hemp seed butter, chia seed butter, flax seed butter, poppy seed butter, or combinations thereof.

6. The composition of claim 3, wherein the one or more plant-based texturizers or stabilizers comprises one or more of guar gum, locust bean gum, gellan gum, xanthan gum, acacia gum, tragacanth gum, pectin, agar, or combinations thereof.

7. The composition of claim 3, wherein the one or more solvents comprise water.

8. The composition of claim 3, wherein the one or more microorganism cultures comprises one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, Torulaspora delbrueckii, or combinations thereof.

9. The composition of claim 1, wherein the one or more plant-based proteins comprises pea protein concentrate, potato protein concentrate, bean protein concentrate, sunflower seed protein concentrate, rapeseed protein, or combinations thereof.

10. The composition of claim 1, wherein the one or more one or more starches comprise hypoallergenic maltodextrin, food starch, modified food starch, or combinations thereof; and the one or more fibers comprise fruit or vegetable soluble fiber concentrates, pomaces, or combinations thereof.

11. The composition of claim 2, wherein the one or more fats comprises one or more of plant-based oils, butters, or creams, including those from sunflower seed, pumpkin seed, watermelon seed, hemp seed, chia seed, flax seed, poppy seed, coconut cream, or combinations thereof.

12. The composition of claim 2, wherein the one or more hydrocolloids, texturizers, or stabilizers comprises one or more of guar gum, locust bean gum, gellan gum, xanthan gum, acacia gum, tragacanth gum, pectin, agar, or combinations thereof.

13. The composition of claim 2, wherein the one or more plant-based emulsifiers comprises one or more of sunflower lecithin, mono and diglycerides, or combinations thereof.

14. The composition of claim 2, wherein the one or more one or more acidulants comprises citric acid, acetic acid, phosphoric acid, fumaric acid, malic acid, tartaric acid, lactic acid, or combinations thereof.

15. The composition of claim 3, wherein the cultured hypoallergenic substrate comprises:
0.1-3.0% by mass of a flour from one or more of millet, sorghum, quinoa, oat, amaranth, einkorn, teff, freekeh, farro (emmer), fonio, spelt, chia seeds, hemp hearts, buckwheat, or combinations thereof;
0.8-10% by mass of one or more of sunflower seed butter, coconut cream, pumpkin seed butter, watermelon seed butter, hemp seed butter, chia seed butter, flax seed butter, poppy seed butter, or combinations thereof;
0.1-0.75% by mass of one or more of guar gum, locust bean gum, gellan gum, xanthan gum, acacia gum, tragacanth gum, pectin, agar, or combinations thereof;
80-98% by mass of water; and
0.001-0.005% by mass of one or more of Bifidobacterium lactis, Lactobacillus acidophilus, Lactobacillus delbrueckii subsp. Bulgaricus, Lactobacillus delbrueckii subsp. Lactis, Lactobacillus helveticus, Lactobacillus kefiranofaciens, Lactobacillus paracasei, Lactobacillus plantarum, Lactococcus lactis, Leuconostoc spp., Pediococcus spp., Streptococcus thermophilus, Kazachstania unispora, Kluyveromyces lactis, Kluyveromyces marxianus, Saccharomyces cerevisiae, Saccharomyces fragilis, Torulaspora delbrueckii, or combinations thereof.

16. The composition of claim 3, wherein the cultured hypoallergenic substrate comprises:
0.1-3.0% by mass of a flour from millet, sorghum, or combinations thereof;
0.8-10% by mass of sunflower seed butter, coconut cream, or combinations thereof;
0.1-0.75% by mass of one or more of guar gum, locust bean gum, gellan gum, xanthan gum, or combinations thereof;
80-98% by mass of water; and
0.001-0.005% by mass of one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof.

17. The composition of claim 3, wherein the cultured hypoallergenic substrate comprises:
0.2-0.8% by mass of a flour from millet, sorghum, or combinations thereof;
1.0-1.5% by mass of sunflower seed butter;
3.0-5.0% by mass of coconut cream;
0.2-0.5% by mass of one or more of guar gum, locust bean gum, gellan gum, xanthan gum, or combinations thereof;
92-95% by mass of water; and
0.002-0.004% by mass of one or more of Bifidobacterium lactis, Lactobacillus acidophilus, Lactobacillus delbrueckii subsp. Bulgaricus, Lactobacillus delbrueckii subsp. Lactis, Lactobacillus plantarum, Streptococcus thermophilus, or combinations thereof.

18. The composition of claim 1, wherein the powdered or concentrated composition is vegan, hypoallergenic, and contains no added monosaccharides or disaccharides.

19. A method for manufacturing a concentrated or powdered cultured plant-based dairy alternative, the method comprising:
combining to form a hypoallergenic slurry:
one or more hypoallergenic-substrates comprising ancient grains or pseudo-cereals;
sunflower seed butter and coconut cream;
one or more stabilizers; and
water;
pasteurizing and homogenizing the hypoallergenic-slurry to form a pasteurized, homogenized hypoallergenic-slurry;
inoculating the pasteurized, homogenized hypoallergenic-slurry with one or more fermentation agents and fermenting for about 4 to 8 hours until the pH is about 4.4 or lower to form a fermented hypoallergenic-slurry; and
increasing percent solids or drying of the fermented hypoallergenic-slurry using one or more of reverse osmosis, nanofiltration, mechanical vapor recompression, spray drying, freeze drying, drum drying, pulse drying or combinations thereof to form the concentrated or powdered cultured plant-based dairy alternative;
or
combining dry hypoallergenic-substrates with dry sunflower seed butter and dry coconut cream with one or more dry starches or fibers; fats; hydrocolloids, texturizers, or stabilizers; plant-based emulsifiers; acidulants, or combinations thereof to form the powdered cultured plant-based dairy alternative.

20-28. (canceled)

29. The method of claim 19, wherein the method further comprises agglomerating the powdered cultured plant-based dairy alternative.

30-42. (canceled)
